(19) United States
(12) Patent Application Publication
(10) Pub. No.: US 2019/0076327 A1
(43) Pub. Date: Mar. 14, 2019

(54) DEVICES AND SYSTEMS WITH AN INTERNAL DISPLACEMENT MECHANISM FOR CONTAMINANT-FREE ENGAGEMENT OF MEDICAL VESSELS AND DEVICES

(71) Applicant: Mikael Naygauz, Forrest Hills, NY (US)

(72) Inventor: Mikael Naygauz, Forrest Hills, NY (US)

(21) Appl. No.: 16/100,740

(22) Filed: Aug. 10, 2018

Related U.S. Application Data
(60) Provisional application No. 62/619,795, filed on Jan. 20, 2018.
(60) Provisional application No. 62/619,920, filed on Jan. 22, 2018.
(60) Provisional application No. 62/562,490, filed on Sep. 25, 2017.
(60) Provisional application No. 62/612,267, filed on Dec. 29, 2017.
(60) Provisional application No. 62/560,195, filed on Sep. 19, 2017.
(60) Provisional application No. 62/558,502, filed on Sep. 14, 2017.
(60) Provisional application No. 62/644,185, filed on Mar. 16, 2018.
(60) Provisional application No. 62/649,483, filed on Mar. 28, 2018.
(60) Provisional application No. 62/657,806, filed on Apr. 14, 2018.

(51) Int. Cl. A61J 1/14; A61J 1/20; A61J 1/10

(52) U.S. Cl. CPC A61J 1/1443; A61J 1/2048; A61J 1/2096; A61J 1/2089; A61J 1/2082; A61J 1/10

(57) ABSTRACT

The present invention relates, in some embodiments thereof, to systems, device and methods for establishing a contaminant-free fluid passageway between vessels. In some embodiments of the invention, the systems and devices of the invention include a first connection interface configured to be coupled to a first vessel, and a second connection interface configured to be coupled to a second vessel, the first and second connection interfaces configured to engage with each other and entrap contaminants, the first connection interface and the second connection interface, following the engagement, are configured to internally displace within the first vessel or the second vessel, while allowing for a contaminant-free fluid passageway and hermetically sealed engagement of the vessels.

### CROSS REFERENCE TO RELATED APPLICATIONS

This application claims the benefit of U.S. Provisional Patent Application No. 62/545,152 filed on Aug. 14, 2017; 62/558,502 filed on Sep. 14, 2017; 62/560,195 filed on Sep. 19, 2017; 62/562,490 filed on Sep. 25, 2017; 62/563,072 filed on Sep. 26, 2017; 62/564,933 filed on Sep. 28, 2017; 62/566,414 filed on Sep. 30, 2017; 62/582,922 filed on Nov. 7, 2017; 62/612,267 filed on Dec. 29, 2017; 62/619,795 filed Jan. 20, 2018; 62/619,920 filed Jan. 22, 2018; 62/625,334 filed on Feb. 1, 2018; 62/626,686 filed on Feb. 6, 2018; 62/631,729 filed on Feb. 17, 2018; 62/644,185 filed on Mar. 16, 2018; 62/649,483 filed on Mar. 28, 2018; 62/651,000 filed on Mar. 30, 2018; 62/651,149 filed on Mar. 31, 2018; 62/653,356 filed on Apr. 5, 2018; 62/657,806 filed on Apr. 14, 2018; 62/657,808 filed on Apr. 15, 2018; 62/657,809 filed on Apr. 15, 2018; 62/660,885 filed on Apr. 20, 2018; 62/662,721 filed on Apr. 25, 2018; 62/662,743 filed on Apr. 25, 2018; 62/664,933 filed on Apr. 30, 2018; 62/666,866 filed on May 4, 2018; 62/667,593 filed on May 6, 2018; 62/669,948 filed on May 10, 2018; 62/670,833 filed on May 13, 2018; 62/675,058 filed on May 22, 2018; 62/676,822 filed on May 25, 2018; 62/679,817 filed on Jun. 3, 2018; 62/680,576 filed on Jun. 4, 2018; 62/680,974 filed on Jun. 5, 2018; 62/681,884 filed on Jun. 7, 2018; 62/686,602 filed on Jun. 18, 2018; 62/686,612 filed on Jun. 18, 2018; and 62/690,260 filed on Jun. 26, 2018. The contents of the above applications are all incorporated by reference as if fully set forth herein in their entirety.

### FIELD OF THE INVENTION

The present invention relates, in some embodiments thereof, to systems and methods establishing a contaminant-free fluid passageway between vessels. In some embodiments of the invention, the systems and devices of the invention include a first connection interface configured to be coupled to a first vessel, and a second connection interface configured to be coupled to a second vessel, the first and second connection interfaces configured to engage with each other and entrap contaminants, the first connection interface and the second connection interface, following the engagement, being configured to internally displace within the first vessel or the second vessel, while allowing for a contaminant-free fluid passageway and hermetically sealed engagement of the vessels.

### BACKGROUND OF THE INVENTION

The medicinal practice routinely involves administration of medical substances, such as, medicaments, fluids, nutritional substances and the alike, to patients or animals. The preparation and/or administration of such medicinal substances typically involves one or more transfers of those substances between pharmaceutical vessels or administration devices (such as, vials, syringes, infusion lines, connectors, etc.). Each such act of transferring substances between vessels or devices exposes the connection interfaces of the vessels and accordingly the medical substances themselves to contaminants present in ambient air or ambient air particles (e.g., bacteria, viruses, funguses, spores, pyrogens, dirt). In addition, connection interfaces are further prone to contaminations due to physical contact of the interfaces, for example, with nonsterile gloves, or devices.

Such contaminations are a major problem in the healthcare setting since contaminants, once invading within medicinal substances, may pose substantial danger if administered intracorporeally to patients.

Typical connection interfaces of pharmaceutical vessels or pharmaceutical administration devices include rubber bungs and/or stoppers covered by a cap and/or seal that can be flicked off and/or are removed prior to usage thereof. These rubber bungs/stoppers are used to allow penetration by a needle attached to a syringe or by other medical connectors. When the cap and/or seal is flicked off and/or removed, the rubber bung and/or stopper is exposed to ambient air and to contaminants present therein. Accordingly, exposure of connection interfaces to ambient air may involve contamination of the interfaces and consequently contamination of a beneficial substance to be provided to a patient.

Existing systems include U.S. D720067; U.S. D717947; U.S. D703812; U.S. D690418; U.S. D639939; U.S. D637713; U.S. Pat. Nos. 9,790,011; 9,775,777; 9,561,326; 9,493,281; 9,492,353; 9,309,020; 9,173,816; 9,168,203; 9,162,803; 9,039,672; 8,926,583; 8,827,978; 8,790,330; 8,662,985; 8,657,803; 8,622,985; 8,562,583; 8,545,475; 8,523,838; 8,491,563; 8,480,646; 8,449,521; 8,381,776; 8,336,587; 8,328,772; 8,287,513; 8,225,826; 8,075,550; 8,029,747; 7,998,134; 7,975,733; 7,942,860; 7,867,215; 7,744,581; 7,731,678; 7,387,216; 7,306,584; 6,875,203; 6,729,370; 6,715,520; 6,602,239; 6,409,708; 6,343,629; 6,162,199; 6,113,583; 6,063,068; 5,893,397; 5,876,380; 5,832,971; 5,807,374; 5,746,733; 5,569,235; 5,462,535; 5,405,326; 5,292,318; 5,279,582; 4,944,723; 4,932,947; 4,932,937; 4,919,657; 4,915,701; 4,826,489; 4,673,404; 4,564,054; 3,610,241; 3,605,743; 3,587,575; 3,583,399; 3,578,037; 3,556,099; 3,552,387; 3,406,686; 3,380,450; 3,375,825; 3,342,180; 3,330,282; 3,330,281; 3,306,290; 3,255,752; 3,253,592; 3,076,456; 2,972,991; 2,922,419; US20160262982; US20160038373; US20150209568; US20140183196; US20140016570; US20140007973; US20140000754; US20130184672; US20130006200; US20120209238; US20120209218; US20120203194; US20110284561; US20110186177; US20110125128; US20110108158; US20110098647; US20100249745; US20100198182; US20100152669; US20100147402; US20100036319; US20100004602; US20090057258; US20080312634; US20080223484; US20080171981; US20060276759; US20050215976; US20030199847; US20030187420; US20020130100; US20020115981; US20020099354; ES2577377T3; EP2852367B1; EP2666513; EP2155141B1.

In order to overcome this obstacle, the current medical practice involves swabbing the surface of a connection interface with a disinfecting agent, such as 70% isopropyl alcohol, prior to accessing the connection interface. Other methods include i.v. (intravenous) rooms which are used for the sterile preparation of i.v. medications. Such rooms, to keep medicinal preparations as sterile as possible, are equipped with special instruments including, hoods with air filtration systems (e.g., HEPA filters), ventilation systems and air pressure systems. Additionally, those rooms necessitate that the medical staff working in these rooms are properly garmented, are properly trained, and require aseptic techniques, and employ quality control and validation processes. These systems require regular upkeep by certified personnel and require regular cleaning. These systems are therefore expensive, labor intensive, and require regular maintenance and testing to assure that they are operating effectively. The above described systems and methods are either cumbersome and expensive or inefficient in addressing the problem of reducing/eliminating contaminants on connection interfaces.

Thus, there is a long felt and unmet need for pharmaceutical vessels, devices, systems and/or methods that afford transfer of medical substances in a sterile manner. There is a need for reliable, user friendly and cost-effective solutions allowing contaminant-free engagement of vessels and devices for drug preparation and administration processes.

### SUMMARY OF THE INVENTION

Objects of the invention are achieved by providing systems, devices and methods for administering medical substances in a decontaminated manner.

Objects of the invention are achieved by providing systems, devices and methods which are directed to the transfer of medical substances in an efficient, user-friendly and sterile manner.

The present invention is based on two or more connection interfaces, each of which is attached to a medical vessel. The connection interfaces are engageable in a manner that allows for the isolation and entrapment of ambient air particles present in the surroundings of the medical vessels. The connection interfaces internally displace within one or more of the vessels, following vessel engagement, while allowing for a contaminant-free fluid passageway and hermetically sealed engagement of the vessels.

In a first aspect, the present invention provides a system for establishing a contaminant-free fluid passageway between vessels, the system comprising: a first connection interface configured to be coupled to a first vessel; and a second connection interface configured to be coupled to a second vessel; wherein the first and second connection interfaces are configured to engage with each other and entrap contaminants, and wherein the first connection interface and the second connection interface, following the engagement, are configured to internally displace within the first vessel or the second vessel, while allowing for a contaminant-free fluid passageway and hermetically sealed engagement of the vessels.

In one or more embodiments, the first connection interface has edges configured to isolate an entire surface of the first connection interface that is exposed to contaminants from contacting an internal compartment of the first vessel and/or the second vessel when the first connection interface is engaged with the second connection interface.

In one or more embodiments, the second connection interface is configured to engage with the first connection interface, the second connection interface having edges configured to isolate an entire surface of the second connection interface that is exposed to contaminants from contacting an internal compartment of the first vessel and/or second vessel when the second connection interface is engaged with the first connection interface.

In one or more embodiments, the first connection interface has edges configured to isolate at least a portion of the surface of the first connection interface that is exposed to contaminants from contacting an internal compartment of the first vessel and/or a second vessel when the first connection interface is engaged with the second connection interface and displaced internally.

In one or more embodiments, the second connection interface has edges configured to isolate at least a portion of the surface of the second connection interface that is exposed to contaminants from contacting an internal compartment of the first vessel and/or second vessel when the second connection interface is engaged with the first connection interface and displaced internally.

In one or more embodiments, when the first connection interface and the second connection interface internally displace within the first vessel and/or the second vessel, no portion of the connection interfaces that are exposed to an internal cavity of the first vessel and/or the second vessel have been exposed to contaminants, allowing for a contaminant-free fluid passageway between the first vessel and the second vessel. In one or more embodiments, at least one of the first and second vessels houses a sterile fluid, wherein no portion of the connection interfaces that are exposed to the fluid have been exposed to contaminants.

In one or more embodiments, when the first connection interface and the second connection interface engage and internally displace within the first vessel and/or second vessel, the entire surface of the first connection interface and the entire surface of the second connection interface that have been exposed to contaminants are isolated between the first connection interface and the second connection interface.

In one or more embodiments, the entire surface of the edges of the first connection interface and the entire surface of the edges of the second connection interface contact each other thus isolating contaminants between the edges of the first connection interface and the edges of the second connection interface.

In one or more embodiments, the entire surface of the first and second connection interfaces that have been exposed to contaminants are isolated between the first and second connection interfaces at about the time and/or after the first and second connection interfaces engage. In one or more embodiments, the engagement between the first and second connection interfaces is an airtight and/or hermetic engagement.

In one or more embodiments, the edges of the first connection interface and the entire surface of the edges of the second connection are circumferential edges. In one or more embodiments, the circumferential edges define the outer portion of the connection interfaces. In one or more embodiments, the edges are further configured so the sides of the edges are not exposed to contaminants and/or are concealed from contaminants. In one or more embodiments, the sides of the edges of the first connection interface and/or the sides of the edges of the second connection interface are concealed within a wall of the first vessel and or within a wall of the second vessel. In one or more embodiments, the sides of the edges of the first and/or the second connection interface are concealed from ambient air and/or contaminants.

In one or more embodiments, the sides of the edges that are exposed to an internal compartment of the first and/or second vessels are not exposed to contaminants. In one or more embodiments, the contaminants are air particles. In one or more embodiments, the contaminants are airborne particles.

In one or more embodiments, upon internal displacement of the first connection interface and the second connection interface, the first vessel and the second vessel are in fluid communication with one another.

In one or more embodiments, both the first connection interface and the second connection interface, following the engagement, are configured to internally displace together within the first vessel or the second vessel. Optionally, the first and second connection interfaces, following engagement, are configured to internally displace together with a port of the first vessel or within a port of the second vessel.

In one or more embodiments, the exterior surface and/or diameter of the first connection interface and the exterior surface and/or diameter of the second connection interface are about equal and/or equal in surface area to allow for the contaminants to be entrapped between the first connection interface and the second connection interface.

In one or more embodiments, the difference in surface area between the exterior surface area of the first connection interface and the exterior surface area of the second connection interface is less than 0.3 inches squared.

In one or more embodiments, the first connection interface and the second connection interface are configured to prevent contaminants from entering the fluid passageway between the first vessel and the second vessel. In one or more embodiments, the first connection interface and the second connection interface are configured to prevent contaminants from entering a port of the first vessel or a port of a second vessel.

In one or more embodiments, the first connection interface and the second connection interface are configured to prevent contaminants from contacting an internal compartment of the first vessel and/or the second vessel. In one or more embodiments, the first connection interface and the second connection interface are configured to prevent contaminants from contacting a fluid that is housed in the first vessel and/or the second vessel.

In one or more embodiments, the first connection interface and/or the second connection interface are configured to hermetically seal an aperture in the first vessel and/or the second vessel.

In one or more embodiments, the aperture is a port. In one or more embodiments, at least one of the first connection interface and the second connection interface are configured to be internally coupled within the aperture in the first vessel and/or the second vessel. In one or more embodiments, the first vessel and/or the second vessel are selected from a vial, a bag, a bottle, a syringe, an infusion line, a connector, a filter, a manifold, a bag port, a bottle port, a vial port, and combinations thereof.

In one or more embodiments, the system further comprises an engagement mechanism configured to securely engage the first vessel and/or second vessel. In one or more embodiments, the engagement mechanism is located on the first vessel and/or the second vessel.

In one or more embodiments, the engagement mechanism is selected from a group consisting of a thread, a luer, an adhesive tape, a ratchet teeth mechanism, and combinations thereof. In one or more embodiments, the engagement mechanism on the first vessel engages a complementary engagement mechanism on the second vessel. In one or more embodiments, the complementary engagement mechanism is selected from a group consisting of a thread, a luer, an adhesive tape, a ratchet teeth mechanism, and combinations thereof.

In one or more embodiments, following the engagement, the engagement mechanism and the complementary engagement mechanism interlock with one another.

In one or more embodiments, the engagement between the first vessel and the second vessel provides for an airtight engagement between the first and second vessels. In one or more embodiments, the system further comprises an engagement mechanism configured to securely engage the first connection interface and the second connection interface. In one or more embodiments, the engagement mechanism is located on the first connection interface and/or on the second connection interface. In one or more embodiments, the engagement mechanism on the first connection interface engages a complementary engagement mechanism on the second connection interface. In one or more embodiments, the engagement mechanism located on the first connection interface is selected from a group consisting of a thread, a luer, an adhesive tape, a ratchet teeth mechanism, and combinations thereof. In one or more embodiments, the complementary engagement mechanism is selected from a group consisting of a thread, a luer, an adhesive tape, a ratchet teeth mechanism, and combinations thereof. In one or more embodiments, following the engagement, the engagement mechanism and the complementary engagement mechanism interlock with one another.

In one or more embodiments, the engagement mechanism secures the first connection interface to the second connection interface forming an airtight seal between the first connection interface and the second connection interface.

In one or more embodiments, the first and/or second connection interfaces are integrally connected to the corresponding first vessel and/or second vessel.

In one or more embodiments, the first vessel and the second vessel are hermetically sealed upon engagement of the vessels. In one or more embodiments, the first vessel and the second vessel are hermetically sealed upon engagement of the vessels and upon engagement of the first and second connection interfaces.

In one or more embodiments, the first connection interface and the second connection interface are hermetically sealed upon engagement of the first connection interface and the second connection interface. In one or more embodiments, the first connection interface and the second connection interface are hermetically sealed upon engagement of the first connection interface and the second connection interface.

In one or more embodiments, a circumference of the first connection interface and a circumference of the second connection interface are equal to allow for the contaminants to be entrapped between the first connection interface and the second connection interface. In one or more embodiments, a circumference of the first connection interface and a circumference of the second connection interface are about equal to allow for the contaminants to be entrapped between the first connection interface and the second connection interface.

In one or more embodiments, edges of the first connection interface and edges of the second connection interface fully entrap contaminants, thus no surface of the edges that contact the internal compartment of the first vessel and/or the second vessel are exposed to the contaminants. In one or more embodiments, the edges of the first connection interface are circumferential edges. In one or more embodiments, the edges of the second connection interface are circumferential edges. In one or more embodiments, the edges of the first connection interface and the edges of the second connection interface are circumferential edges.

In one or more embodiments, an internal fluid passageway between the first vessel and the second vessel is devoid of contaminants and/or ambient/environmental air. In one or more embodiments, an internal fluid passageway between the first vessel and the second vessel is sterile and/or pyrogen-free.

In one or more embodiments, at least one of the first connection interface and the second connection interface is a selected from a group consisting of a film, a bung, a plug and combinations thereof. In one or more embodiments, the film is a plastic, a polymer or a metal alloy. In one or more embodiments, the bung is made of a rubber or an elastomeric material. In one or more embodiments, the plug is made of a plastic, an elastomeric material, a rubber and combination thereof. In one or more embodiments, the first connection interface and/or the second connection interface has and/or is attached to an engagement mechanism. In one or more embodiments, the engagement mechanism of the first and/or second connection interface is selected from a thread, a luer, a ratchet teeth mechanism, a snap-on mechanism and combinations thereof. In one or more embodiments, the first connection interface engages the second connection interface via the engagement mechanism. In one or more embodiments, the engagement mechanism provides for an airtight and/or hermetic seal between the first and second connection interfaces. In one or more embodiments, the airtight and/or hermetic seal between the first connection interface and the second connection interface entraps contaminants, such as ambient air particles, between the first and second connection interfaces.

In one or more embodiments, the first connection interface is configured to seal and/or cover a port of the first vessel and/or a port of the second vessel. In one or more embodiments, the first connection interface and the second connection interface are configured to seal and/or cover an aperture of the first vessel and an aperture of the second vessel, respectively. In one or more embodiments, the edges of the first connection interface and/or the edges of the second connection interface are flat. In one or more embodiments, the edges of the first connection interface and the edges of the second connection interface are configured to snuggly fit to one another. In one or more embodiments, the edges of the first connection interface and the edges of the second connection interface are configured to entrap air particles between the entire portion of the edges of the first and/or second connection interfaces. In one or more embodiments, the external edges of the first connection interface and the external edges of the second connection interface are configured to entrap air particles between the connection interfaces. In one or more embodiments, the external edges of the first connection interface and/or the external edges of the second connection interface are concealed within a portion of the first vessel and/or within a portion of the second vessel. In one or more embodiments, the external edges of the first connection interface and/or the external edges of the second connection interface are concealed within a wall of the first vessel and/or within a wall of the second vessel. In one or more embodiments, the external edges of the first connection interface and/or the external edges of the second connection interface are concealed within a port of the first vessel and/or within a port of the second vessel.

In a further aspect, the present invention provides a method of decontaminating a connection between two vessels, the method comprising the steps of: providing a first connection interface attached to a first vessel; providing a second connection interface attached to a second vessel, engaging the first vessel to the second vessel; and internally displacing the first and second connection interfaces within one of the first vessel or the second vessel, while a hermetically sealed connection between the first and second vessel is maintained.

In one or more embodiments, internal displacement of the first and second connection interfaces occurs within a port of the first and/or second vessel.

In one or more embodiments, internal displacement of the first and second connection interfaces occurs within an inner chamber or compartment of the first and/or second vessel. In one or more embodiments, internal displacement of the first and second connection interfaces occurs within a fluid chamber or fluid compartment of the first and/or second vessel.

In one or more embodiments, the first connection interface has edges configured to isolate an entire surface of the first connection interface that is exposed to contaminants from contacting an internal compartment of the first vessel and/or the second vessel when the first connection interface is engaged with the second connection interface, and wherein the second connection interface is configured to engage with the first connection interface, the second connection interface having edges configured to isolate an entire surface of the second connection interface that is exposed to contaminants from contacting an internal compartment of the first vessel and/or second vessel when the second connection interface is engaged with the first connection interface. In one or more embodiments, the internal compartment of the first and/or second vessel houses a fluid. In one or more embodiments, the internal compartment of the first and/or second vessel houses a beneficial substance. In one or more embodiments, the beneficial substance is a medicament.

In one or more embodiments, the first connection interface has edges configured to isolate a portion of the surface of the first connection interface that is exposed to contaminants from contacting an internal compartment of the first vessel and/or a second vessel when the first connection interface is engaged with the second connection interface, and wherein the second connection interface has edges configured to isolate a portion of the surface of the second connection interface that is exposed to contaminants from contacting an internal compartment of the first vessel and/or second vessel when the second connection interface is engaged with the first connection interface.

In one or more embodiments, an airtight seal is formed between the first connection interface and the second connection interface prior to the internal displacement of the first and second connection interfaces. In one or more embodiments, when the airtight seal between the first connection interface and the second connection interface is displaced, the connection between the first vessel and the second vessel is decontaminated.

In one or more embodiments, an airtight seal is formed between the first connection interface and the second connection interface at about the time of internal displacement of the first and second connection interfaces.

In one or more embodiments, circumferential edges of at least one of or both of the first and second connection interfaces ends are concealed within the airtight seal between the first and second connection interfaces, allowing for sterile internal displacement. In one or more embodiments, the circumferential edges of at least one or both of the first and second connection interfaces are externally facing circumferential edges. In one or more embodiments, the externally facing circumferential edges are exposed to air, ambient air, environmental air, and/or contaminants present in air prior to the engagement of the first and second connection interfaces. In one or more embodiments, at about the time or after engagement of the first and second connection interfaces the ends, circumferential edges and/or externally facing circumferential edges of the first and/or second connection interfaces engage tightly/snuggly with one another and contaminants are entrapped between the ends, circumferential edges and/or externally facing circumferential edges. In one or more embodiments, externally facing means exposed to ambient air, environmental air, and/or contaminants. In one or more embodiments, externally facing means exposed to an inner compartment and/or chamber of a port and/or a vessel after engagement and internal displacement of the first and second connection interfaces.

In one or more embodiments, when the circumferential edges of both the first and second connection interfaces ends are aligned, an airtight seal is formed between first and second connection interfaces, allowing for internal displacement of first and second connection interfaces and a contaminant free fluid passageway between the first and second vessels. In one or more embodiments, the method further comprises connecting the first connection interface to the second connection interface via an engagement mechanism.

In one or more embodiments, connecting of the first connection interface to the second connection interface is selected from a twisting of a thread onto a complementary thread, attaching ratchet teeth to a complementary retention member, and adhering a first connection interface to the second connection interface via an adhesive.

In one or more embodiments, the engagement of first connection interface to the second connection interface occurs prior to internal displacement of the connection interfaces.

In yet a further aspect, the present invention provides a decontamination connector for providing a decontaminated connection and fluid passageway between a first vessel and a second vessel, the decontamination connector comprising: a housing having a conduit disposed within the housing, wherein a first end of the conduit leads to a first opening in the housing and wherein a second end of the conduit leads to a second opening in the housing; and a first internally displaceable connection interface covering the first opening of the conduit and a second internally displaceable interface covering the second opening of the conduit, wherein upon internal displacement of the first and second connection interfaces of the decontamination connector, a fluidic passageway is established between two vessels.

In yet a further aspect, the present invention provides a system for providing a fluidic passageway between a first vessel and a second vessel, the system comprising: a first vessel having a first connection interface, wherein the first connection interface is configured to couple with a third connection interface of a decontamination connector and internally displace within the first vessel or the decontamination connector; a second vessel having a second connection interface, wherein the second connection interface is configured to couple with a fourth connection interface of a decontamination connector and internally displace within the second vessel or the decontamination connector; and a decontamination connector having a third connection interface configured to couple with the first connection interface of the first vessel, wherein the first and third connection interfaces when coupled internally displace within the first vessel or the decontamination connector and the decontamination connector having a fourth connection interface configured to couple with the second connection interface of the second vessel, wherein the second and fourth connection interfaces when coupled internally displace within the second vessel or the decontamination connector, wherein following engagement and internal displacement of the first and third connection interfaces and following engagement and internal displacement of the second and fourth connection interfaces a contaminant-free fluidic communication is established between the first vessel and the second vessel via the decontamination connector.

In one or more embodiments, the decontamination connector further comprises an engagement mechanism, wherein the engagement mechanism is configured to provide a coupling between the first connection interface of the first vessel and the third connection interface of the decontamination connector. In one or more embodiments, the engagement mechanism is selected from a group consisting of a thread, a luer, an adhesive, a clamping rail, a rail, a ratchet teeth mechanism, and combinations thereof. In one or more embodiments, the engagement mechanism is made of a plastic, a metal, an elastomeric substance, a rubber and combinations thereof. In one or more embodiments, the decontamination connector comprises two of said engagement mechanisms. In one or more embodiments, the decontamination may comprise a plurality of said engagement mechanism. In one or more embodiments, the decontamination connector may comprise three or more internally displaceable connection interfaces. In one or more embodiments, the decontamination connector may comprise at least three internally displaceable connection interfaces and at least three engagement mechanisms.

In one or more embodiments, the first connection interface is selected from a group consisting of a film, a bung, a plug and combinations thereof. In one or more embodiments, the first connection interface is made of plastic, rubber, elastomeric material, and combinations thereof. In one or more embodiments, the first connection interface is configured to displace internally within the decontamination connector and/or the first vessel.

or more embodiments, the second connection interface is selected from a group consisting of a film, a bung, a plug and combinations thereof. In one or more embodiments, the second connection interface is made of plastic, rubber, elastomeric material, and combinations thereof. In one or more embodiments, the second connection interface is configured to displace internally within the decontamination connector and/or the first vessel.

or more embodiments, the third connection interface is selected from a group consisting of a film, a bung, a plug and combinations thereof. In one or more embodiments, the third connection interface is made of plastic, rubber, elastomeric material, and combinations thereof. In one or more embodiments, the third connection interface is configured to displace internally within the decontamination connector and/or the first vessel.

or more embodiments, the fourth connection interface is selected from a group consisting of a film, a bung, a plug and combinations thereof. In one or more embodiments, the fourth connection interface is made of plastic, rubber, elastomeric material, and combinations thereof. In one or more embodiments, the fourth connection interface is configured to displace internally within the decontamination connector and/or the first vessel.

In one or more embodiments, an entire surface of the first connection interface and an entire surface of the third connection interface contact each other thus isolating contaminants between the surface of the first connection interface and the surface of the third connection interface.

In one or more embodiments, an entire surface of the second connection interface and an entire surface of the fourth connection interface contact each other thus isolating contaminants between the surface of the second connection interface and the surface of the fourth connection interface.

In one or more embodiments, a portion of a surface of the first connection interface and a portion of a surface of the third connection interface contact each other thus isolating contaminants between the surface of the first connection interface and the surface of the third connection interface.

In one or more embodiments, a portion of a surface of the second connection interface and a portion of a surface of the fourth connection interface contact each other thus isolating contaminants between the surface of the second connection interface and the surface of the fourth connection interface.

In one or more embodiments, the first connection interface has edges configured to isolate an entire surface of the first connection interface that is exposed to contaminants from contacting an internal compartment of the first vessel and/or the decontamination connector when the first connection interface is engaged with the third connection interface.

In one or more embodiments, the second connection interface has edges configured to isolate an entire surface of the second connection interface that is exposed to contaminants from contacting an internal compartment of the second vessel and/or the decontamination connector when the second connection interface is engaged with the fourth connection interface.

In one or more embodiments, the first connection interface has edges configured to isolate a portion of the surface of the first connection interface that is exposed to contaminants from contacting an internal compartment of the first vessel and/or the decontamination connector when the first connection interface is engaged with the third connection interface. In one or more embodiments, the edges are circumferential edges. In one or more embodiments, the circumferential edges define the outer portion of the first connection interface and the third connection interface. In one or more embodiments, the edges are further configured so the sides of the edges are not exposed to contaminants. In one or more embodiments, the sides of the edges that are exposed to an internal compartment of the first vessel and/or the decontamination connector are not exposed to contaminants. In one or more embodiments, the outer portion of the edges of the first connection interface are not exposed to contaminants. In one or more embodiments, the edges of the first connection interface are configured to fully entrap the contaminants between the first and third connection interfaces upon engagement of the first and third connection interfaces. In one or more embodiments, the edges of the first connection interface are flat. In one or more embodiments, the edges of the first connection interface are configured to snuggly fit the edges of the third connection interface of the decontamination connector. In one or more embodiments, the edges of the first connection interface are an exterior portion of the connection interface that comes in contact with an interior compartment of the decontamination connector and/or vessel.

In one or more embodiments, the second connection interface has edges configured to isolate a portion of the surface of the second connection interface that is exposed to contaminants from contacting an internal compartment of the second vessel and/or the decontamination connector when the second connection interface is engaged with the fourth connection interface. In one or more embodiments, the edges are circumferential edges. In one or more embodiments, the circumferential edges define the outer portion of the second connection interface and the fourth connection interface. In one or more embodiments, the edges are further configured so the sides of the edges are not exposed to contaminants. In one or more embodiments, the sides of the edges that are exposed to an internal compartment of the second vessel and/or the decontamination connector are not exposed to contaminants. In one or more embodiments, the outer portion of the edges of the second connection interface are not exposed to contaminants. In one or more embodiments, the edges of the second connection interface are configured to fully entrap the contaminants between the second and fourth connection interfaces upon engagement of the second and fourth connection interfaces. In one or more embodiments, the edges of the second connection interface are flat. In one or more embodiments, the edges of the second connection interface are configured to snuggly fit the edges of the fourth connection interface of the decontamination connector. In one or more embodiments, the edges of the second connection interface are an exterior portion of the connection interface that comes in contact with an interior compartment of the decontamination connector and/or vessel.

In one or more embodiments, the contaminants are air particles. In one or more embodiments, the contaminants are water particles.

In one or more embodiments, the first connection interface and the third connection interface are configured to prevent contaminants from contacting the fluid passageway established between the decontamination connector and the first vessel.

In one or more embodiments, the second connection interface and the fourth connection interface are configured to prevent contaminants from contacting the fluid passageway established between the decontamination connector and the second vessel.

In one or more embodiments, the first connection interface and the third connection interface are configured to prevent a surface of the first and third connection interfaces that are exposed to contaminants from contacting a fluid passageway and/or interior compartment of the first vessel and/or decontamination connector.

In one or more embodiments, the second connection interface and the fourth connection interface are configured to prevent a surface of the second and fourth connection interfaces that are exposed to contaminants from contacting a fluid passageway and/or interior compartment of the second vessel and/or decontamination connector.

In one or more embodiments, the first connection interface is configured to hermetically seal an aperture of the first vessel. In one or more embodiments, the second connection interface is configured to hermetically seal an aperture of the second vessel. In one or more embodiments, the third connection interface is configured to hermetically seal an aperture of the decontamination connector. In one or more embodiments, the fourth connection interface is configured to hermetically seal an aperture of the decontamination connector.

In one or more embodiments, the first and/or second connection interfaces is configured to be internally coupled within the aperture and/or conduit of the decontamination connector.

In one or more embodiments, the aperture is a port. In one or more embodiments, the first and/or second vessels are selected from a vial, a bag, a bottle, a syringe, an infusion line, a connector, a filter, a manifold, a spike, a manifold port, a bag port, a bottle port, a vial port, and combinations thereof.

In one or more embodiments, the decontamination connector further comprises an engagement mechanism configured to securely engage the decontamination connector with the first vessel. In one or more embodiments, the decontamination connector further comprises a second engagement mechanism configured to securely engage the decontamination connector with the second vessel. In one or more embodiments, the engagement mechanism(s) provides an airtight engagement between the decontamination connector and the vessel.

In one or more embodiments, at least one of the engagement mechanisms is selected from a thread, a luer, ratchet teeth mechanism, adhesive, a rail and combinations thereof. In one or more embodiments, the engagement mechanism is located on the first connection interface.

In one or more embodiments, the engagement mechanism engages a complimentary engagement mechanism on a first and/or second connection interface.

In one or more embodiments, the engagement mechanism forms an airtight seal between the first connection interface and the third connection interface.

In one or more embodiments, the third and/or fourth connection interfaces are integrally connected to the decontamination connector.

In one or more embodiments, the decontamination connector and the vessel are hermetically sealed upon engagement of the first and third connection interfaces and/or the second and the fourth connection interfaces.

In one or more embodiments, the internal fluid passageway between the decontamination connector and the first and/or second vessel is devoid of air particles. In one or more embodiments, the internal fluid passageway between the decontamination connector and the first and/or second vessel is devoid of air particles at about the time or after internal displacement of the first and third connection interfaces and/or the second and fourth connection interfaces.

In one or more embodiments, the internal fluid passageway between the decontamination connector and at least one vessel is sterile. In one or more embodiments, the internal fluid passageway between the decontamination connector and a first and/or third vessel is sterile at about the time or after internal displacement of the first and second connection interfaces and/or the second and fourth connection interfaces.

Unless otherwise defined, all technical or/and scientific terms used herein have the same meaning as commonly understood by one of ordinary skill in the art to which the invention pertains. Although methods and materials similar or equivalent to those described herein can be used in the practice or testing of embodiments of the invention, exemplary methods or/and materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-1C are schematic side cut view illustrations presenting an exemplary system which includes a first connection interface coupled to a first vessel and a second connection interface coupled to a second vessel, the first connection interface and the second connection interface configured to engage with each other and to internally displace within the first vessel or the second vessel, allowing a hermetic and decontaminated communication between the first vessel and the second vessel, according to some embodiments of the invention.

FIGS. 2A-2C are schematic side cut view illustrations, presenting a further exemplary system which includes a first connection interface coupled to a first vessel and a second connection interface coupled to a second vessel, the first connection interface and the second connection interface including circumferential edges being complementary to each other and configured to allow for an engagement of the connection interfaces, thereby establishing a hermetic and decontaminated communication between the first vessel and the second vessel, according to some embodiments of the invention.

FIGS. 3A-3C are schematic side cut view illustrations presenting yet a further exemplary system which includes a first connection interface coupled to a first vessel and a second connection interface coupled to a second vessel, the connection interfaces further including a thread engagement mechanism configured to provide a secure engagement between the first connection interface and the second connection interface, according to some embodiments of the invention.

FIG. 4 is a schematic side cut view illustration presenting yet a further exemplary system which includes a first connection interface coupled to a first vessel and a second connection interface coupled to a second vessel, the connection interfaces further including a retention-keeper engagement mechanism configured to provide a secure engagement between the connection interfaces, according to some embodiments of the invention.

FIGS. 5A-5E are schematic illustrations presenting yet a further exemplary system which includes a first connection interface coupled to a first vessel and a second connection interface coupled to a second vessel, the first connection interface includes a seal case configured to accommodate the first connection interface and second connection interface and to allow the connection interfaces to engage with each other and internally displace within the first vessel, according to some embodiments of the invention.

FIGS. 6A-6C are schematic illustrations presenting yet a further exemplary system which includes a first connection interface coupled to a first vessel and a second connection interface coupled to a second vessel, the first connection interface includes a seal case configured to accommodate the first connection interface and the second connection interface, the connection interfaces further include a thread engagement mechanism configured to provide a secure engagement between the connection interfaces, according to some embodiments of the invention.

FIGS. 7A-7C are schematic illustrations presenting yet a further exemplary system which includes a first connection interface coupled to a first vessel and a second connection interface coupled to a second vessel, the first connection interface includes a seal case configured to accommodate the first and second connection interfaces, the connection interfaces further include a ratchet teeth engagement mechanism configured to provide a secure engagement between the connection interfaces, according to some embodiments of the invention;

FIGS. 8A-8C are schematic side cut views illustrations presenting yet a further exemplary system which includes a first connection interface coupled to a first vessel and a second connection interface coupled to a second vessel, the connection interfaces further include an engagement mechanism configured to provide a secure engagement between the vessels, according to some embodiments of the invention.

FIG. 9 is a schematic illustration presenting a system which includes a connection interface coupled to a vessel, the connection interface configured to be attached to a complementary connection interface which may be present on different types of vessels, according to some embodiments of the invention.

FIG. 10 is a schematic illustration presenting a first vessel attached to a plurality of connection interfaces, each of which is configured to engage with a complementary connection interface present on another medical vessel, according to some embodiments, of the invention.

FIG. 11 is a schematic illustration presenting a system which includes a first connection interface coupled to a first vessel, a second connection interface coupled to a second vessel and a connector coupled at opposing ends thereof to a third and a forth connection interfaces, the first and second vessels are engaged via coupling to the connector and internal displacement of the connection interfaces, establishing a hermetic and decontaminated communication between the first and second vessels via the connector, according to some embodiments of the invention.

FIG. 12 is a schematic illustration presenting a system wherein various types of medical vessels may be attached to connection interfaces, wherein a connector mediates the engagement and fluid passageway between the vessels, according to some embodiments of the invention.

It should be appreciated that for simplicity and clarity of illustration, elements shown in the figures have not necessarily been drawn to scale. For example, the dimensions of some of the elements are exaggerated relative to each other for clarity. Further, where considered appropriate, reference numerals have been repeated among the figures to indicate corresponding elements.

### DETAILED DESCRIPTION OF THE INVENTION

It is understood that the invention is not limited to the particular methodology, devices, items or products etc., described herein, as these may vary as the skilled artisan will recognize. It is also to be understood that the terminology used herein is used for the purpose of describing particular embodiments only, and is not intended to limit the scope of the invention. The following exemplary embodiments may be described in the context of exemplary bedding articles for ease of description and understanding. However, the invention is not limited to the specifically described products and methods and may be adapted to various applications without departing from the overall scope of the invention. All ranges disclosed herein include the endpoints. The use of the term “or” shall be construed to mean “and/or” unless the specific context indicates otherwise.

The present invention relates to devices, methods and systems allowing an engagement of vessels in a sterile manner. The present devices, methods and systems are particularly useful for medical purposes, wherein sterile preparations of medical substances are vastly needed. In one embodiment, the present invention provides connection interfaces, that may be coupled to, or integrally formed with, medical vessels or containers, such as vials, syringes, etc. The invention provides a solution to an unmet and long felt need in the medical settings and allows connecting, in a sterile manner, two or more vessels. The herein disclosed devices and systems are user friendly, cost effective and abolish the need for complicated and expensive known methods for transferring medical substances. In an embodiment of the invention, the herein disclosed devices and systems are disposable. In an embodiment of the invention, the herein disclosed devices and systems are non-disposable.

In an aspect of the invention, the devices and systems of the invention include a first connection interface configured to attach to a first vessel and a second connection interface configured to attach to a second vessel. The first and second connection interfaces are designed in a manner allowing them to engage with each other. An engagement between the interfaces entraps ambient air particles present at the vicinity of the vessels and interfaces. The air particles are entrapped within the engagement formed by the connection interfaces. The air particles are entrapped between the connection interfaces of the first and second vessels. The engagement between the connection interfaces further establishes an airtight seal between the vessels. The connection interfaces are further configured to internally displace within one of the vessels or within one of the vessel ports, thereby allowing fluid passageway and contaminant-free connection of the vessels.

In an aspect of the invention, the devices and systems of the invention includes a first connection interface with edges configured to isolate an entire surface of the first connection interface that is exposed to contaminants from contacting an internal compartment of the first vessel and/or the second vessel when the first connection interface is engaged with the second connection interface. In an aspect of the invention, the second connection interface is configured to engage with the first connection interface, the second connection interface having edges configured to isolate an entire surface of the second connection interface that is exposed to contaminants from contacting an internal compartment of the first vessel and/or second vessel when the second connection interface is engaged with the first connection interface.

In one or more embodiments, the entire surface of the edges of the first connection interface and the entire surface of the edges of the second connection interface contact each other thus isolating contaminants between the edges of the first connection interface and the edges of the second connection interface. In one or more embodiments, the edges of the first connection interface and the entire surface of the edges of the second connection are circumferential edges. In one or more embodiments, the circumferential edges define the outer portion of the connection interfaces. In one or more embodiments, the edges are further configured so the sides of the edges are not exposed to contaminants and/or are concealed from contaminants. In one or more embodiments, the sides of the edges of the first connection interface and/or the sides of the edges of the second connection interface are concealed within a wall or other portion of the first vessel and or within a wall or other portion of the second vessel.

In one or more embodiments, the sides of the edges that are exposed to an internal compartment or port of the first and/or second vessels are not exposed to contaminants.

In one or more embodiments, the herein disclosed invention allows transferring medical substances in a contaminant-free, or in a substantially contaminant-free manner.

In one or more embodiments, the herein disclosed invention affords an engagement of vessels in a sterile manner.

In one or more embodiments, the herein disclosed invention provides a fluidic passageway or communication between vessels in a contaminant-free, or in a substantially contaminant-free manner.

In one or more embodiments, the herein disclosed invention affords to isolate and/or entrap ambient air particles present between two or more, medical vessels. In one or more embodiments, the herein disclosed invention, allows to substantially decrease the chances to introduce contaminants within a medical substance, when preparing medical substances for administration to patients.

In yet a further aspect, the present invention provides a decontamination connector for providing a decontaminated connection and fluid passageway between a first vessel and a second vessel, the decontamination connector comprising:

a housing having a conduit disposed within the housing, wherein a first end of the conduit leads to a first opening in the housing and wherein a second end of the conduit leads to a second opening in the housing; and

a first internally displaceable connection interface covering the first opening of the conduit and a second internally displaceable interface covering the second opening of the conduit,

wherein upon internal displacement of the first and second connection interfaces of the decontamination connector, a fluidic passageway is established between two vessels.

In yet a further aspect, the present invention provides a system for providing a fluidic passageway between a first vessel and a second vessel, the system comprising:

a first vessel having a first connection interface, wherein the first connection interface is configured to couple with a third connection interface of a decontamination connector and internally displace within the first vessel or the decontamination connector;

a second vessel having a second connection interface, wherein the second connection interface is configured to couple with a fourth connection interface of a decontamination connector and internally displace within the second vessel or the decontamination connector; and

a decontamination connector having a third connection interface configured to couple with the first connection interface of the first vessel, wherein the first and third connection interfaces when coupled internally displace within the first vessel or the decontamination connector and the decontamination connector having a fourth connection interface configured to couple with the second connection interface of the second vessel, wherein the second and fourth connection interfaces when coupled internally displace within the second vessel or the decontamination connector,

wherein following engagement and internal displacement of the first and third connection interfaces and following engagement and internal displacement of the second and fourth connection interfaces a contaminant-free fluidic communication is established between the first vessel and the second vessel via the decontamination connector.

In one or more embodiments, the decontamination connector further comprises an engagement mechanism, wherein the engagement mechanism is configured to provide a coupling between the first connection interface of the first vessel and the third connection interface of the decontamination connector. In one or more embodiments, the engagement mechanism is selected from a group consisting of a thread, a luer, an adhesive, a clamping rail, a rail, a ratchet teeth mechanism, and combinations thereof. In one or more embodiments, the engagement mechanism is made of a plastic, a metal, an elastomeric substance, a rubber and combinations thereof. In one or more embodiments, the decontamination connector comprises two of said engagement mechanisms. In one or more embodiments, the decontamination may comprise a plurality of said engagement mechanism. In one or more embodiments, the decontamination connector may comprise three or more internally displaceable connection interfaces. In one or more embodiments, the decontamination connector may comprise at least three internally displaceable connection interfaces and at least three engagement mechanisms.

In one or more embodiments, the first connection interface is selected from a group consisting of a film, a bung, a plug and combinations thereof. In one or more embodiments, the first connection interface is made of plastic, rubber, elastomeric material, and combinations thereof. In one or more embodiments, the first connection interface is configured to displace internally within the decontamination connector and/or the first vessel.

or more embodiments, the second connection interface is selected from a group consisting of a film, a bung, a plug and combinations thereof. In one or more embodiments, the second connection interface is made of plastic, rubber, elastomeric material, and combinations thereof. In one or more embodiments, the second connection interface is configured to displace internally within the decontamination connector and/or the first vessel.

or more embodiments, the third connection interface is selected from a group consisting of a film, a bung, a plug and combinations thereof. In one or more embodiments, the third connection interface is made of plastic, rubber, elastomeric material, and combinations thereof. In one or more embodiments, the third connection interface is configured to displace internally within the decontamination connector and/or the first vessel.

or more embodiments, the fourth connection interface is selected from a group consisting of a film, a bung, a plug and combinations thereof. In one or more embodiments, the fourth connection interface is made of plastic, rubber, elastomeric material, and combinations thereof. In one or more embodiments, the fourth connection interface is configured to displace internally within the decontamination connector and/or the first vessel.

In one or more embodiments, an entire surface of the first connection interface and an entire surface of the third connection interface contact each other thus isolating contaminants between the surface of the first connection interface and the surface of the third connection interface.

In one or more embodiments, an entire surface of the second connection interface and an entire surface of the fourth connection interface contact each other thus isolating contaminants between the surface of the second connection interface and the surface of the fourth connection interface.

In one or more embodiments, a portion of a surface of the first connection interface and a portion of a surface of the third connection interface contact each other thus isolating contaminants between the surface of the first connection interface and the surface of the third connection interface.

In one or more embodiments, a portion of a surface of the second connection interface and a portion of a surface of the fourth connection interface contact each other thus isolating contaminants between the surface of the second connection interface and the surface of the fourth connection interface.

In one or more embodiments, the first connection interface has edges configured to isolate an entire surface of the first connection interface that is exposed to contaminants from contacting an internal compartment of the first vessel and/or the decontamination connector when the first connection interface is engaged with the third connection interface.

In one or more embodiments, the second connection interface has edges configured to isolate an entire surface of the second connection interface that is exposed to contaminants from contacting an internal compartment of the second vessel and/or the decontamination connector when the second connection interface is engaged with the fourth connection interface.

In one or more embodiments, the first connection interface has edges configured to isolate a portion of the surface of the first connection interface that is exposed to contaminants from contacting an internal compartment of the first vessel and/or the decontamination connector when the first connection interface is engaged with the third connection interface. In one or more embodiments, the edges are circumferential edges. In one or more embodiments, the circumferential edges define the outer portion of the first connection interface and the third connection interface. In one or more embodiments, the edges are further configured so the sides of the edges are not exposed to contaminants. In one or more embodiments, the sides of the edges that are exposed to an internal compartment of the first vessel and/or the decontamination connector are not exposed to contaminants. In one or more embodiments, the outer portion of the edges of the first connection interface are not exposed to contaminants. In one or more embodiments, the edges of the first connection interface are configured to fully entrap the contaminants between the first and third connection interfaces upon engagement of the first and third connection interfaces. In one or more embodiments, the edges of the first connection interface are flat. In one or more embodiments, the edges of the first connection interface are configured to snuggly fit the edges of the third connection interface of the decontamination connector. In one or more embodiments, the edges of the first connection interface are an exterior portion of the connection interface that comes in contact with an interior compartment of the decontamination connector and/or vessel.

In one or more embodiments, the second connection interface has edges configured to isolate a portion of the surface of the second connection interface that is exposed to contaminants from contacting an internal compartment of the second vessel and/or the decontamination connector when the second connection interface is engaged with the fourth connection interface. In one or more embodiments, the edges are circumferential edges. In one or more embodiments, the circumferential edges define the outer portion of the second connection interface and the fourth connection interface. In one or more embodiments, the edges are further configured so the sides of the edges are not exposed to contaminants. In one or more embodiments, the sides of the edges that are exposed to an internal compartment of the second vessel and/or the decontamination connector are not exposed to contaminants. In one or more embodiments, the outer portion of the edges of the second connection interface are not exposed to contaminants. In one or more embodiments, the edges of the second connection interface are configured to fully entrap the contaminants between the second and fourth connection interfaces upon engagement of the second and fourth connection interfaces. In one or more embodiments, the edges of the second connection interface are flat. In one or more embodiments, the edges of the second connection interface are configured to snuggly fit the edges of the fourth connection interface of the decontamination connector. In one or more embodiments, the edges of the second connection interface are an exterior portion of the connection interface that comes in contact with an interior compartment of the decontamination connector and/or vessel.

In one or more embodiments, the contaminants are air particles. In one or more embodiments, the contaminants are water particles.

In one or more embodiments, the first connection interface and the third connection interface are configured to prevent contaminants from contacting the fluid passageway established between the decontamination connector and the first vessel.

In one or more embodiments, the second connection interface and the fourth connection interface are configured to prevent contaminants from contacting the fluid passageway established between the decontamination connector and the second vessel.

In one or more embodiments, the first connection interface and the third connection interface are configured to prevent a surface of the first and third connection interfaces that are exposed to contaminants from contacting a fluid passageway and/or interior compartment of the first vessel and/or decontamination connector.

In one or more embodiments, the second connection interface and the fourth connection interface are configured to prevent a surface of the second and fourth connection interfaces that are exposed to contaminants from contacting a fluid passageway and/or interior compartment of the second vessel and/or decontamination connector.

In one or more embodiments, the first connection interface is configured to hermetically seal an aperture of the first vessel. In one or more embodiments, the second connection interface is configured to hermetically seal an aperture of the second vessel. In one or more embodiments, the third connection interface is configured to hermetically seal an aperture of the decontamination connector. In one or more embodiments, the fourth connection interface is configured to hermetically seal an aperture of the decontamination connector.

In one or more embodiments, the first and/or second connection interfaces is configured to be internally coupled within the aperture and/or conduit of the decontamination connector.

In one or more embodiments, the aperture is a port. In one or more embodiments, the first and/or second vessels are selected from a vial, a bag, a bottle, a syringe, an infusion line, a connector, a filter, a manifold, a spike, a manifold port, a bag port, a bottle port, a vial port, and combinations thereof.

In one or more embodiments, the decontamination connector further comprises an engagement mechanism configured to securely engage the decontamination connector with the first vessel.

In one or more embodiments, the decontamination connector further comprises a second engagement mechanism configured to securely engage the decontamination connector with the second vessel.

In one or more embodiments, the engagement mechanism(s) provides an airtight engagement between the decontamination connector and the vessel.

In one or more embodiments, at least one of the engagement mechanisms is selected from a thread, a luer, ratchet teeth mechanism, adhesive, a rail and combinations thereof. In one or more embodiments, the engagement mechanism is located on the first connection interface.

In one or more embodiments, the engagement mechanism engages a complimentary engagement mechanism on a first and/or second connection interface.

In one or more embodiments, the engagement mechanism forms an airtight seal between the first connection interface and the third connection interface.

In one or more embodiments, the third and/or fourth connection interfaces are integrally connected to the decontamination connector.

In one or more embodiments, the decontamination connector and the vessel are hermetically sealed upon engagement of the first and third connection interfaces and/or the second and the fourth connection interfaces.

In one or more embodiments, the internal fluid passageway between the decontamination connector and the first and/or second vessel is devoid of air particles.

In one or more embodiments, the internal fluid passageway between the decontamination connector and the first and/or second vessel is devoid of air particles at about the time or after internal displacement of the first and third connection interfaces and/or the second and fourth connection interfaces.

In one or more embodiments, the internal fluid passageway between the decontamination connector and at least one vessel is sterile.

In one or more embodiments, the internal fluid passageway between the decontamination connector and a first and/or third vessel is sterile at about the time or after internal displacement of the first and second connection interfaces and/or the second and fourth connection interfaces.

As used herein the term “substances” refers to various types of materials that should be kept sterile. The substances may be liquid, solid, semi-solid, or gas. In one or more embodiments, the substances are “medical substances”. As used herein the term “medical substances” refers to and encompasses any of the various medical drugs, fluids, nutritional products, liquids, solids, suspensions and the like.

As used herein the term “contaminant-free” is interchangeable with the term “sterile”, “disinfected”, and “decontaminated”. The term refers to substances that are free or substantially free of ambient air particles and/or pathogens. Typically, when less or no air is introduced within medical substances, the chances of contamination by pathogens, such as, bacteria, viruses, funguses, spores, pyrogens or the alike is completely abolished or significantly reduced.

As used herein, the term “substantially contaminant-free” means significantly less ambient air present when transferring medical substances with the herein disclosed vessels and systems, as compared to comparable conditions for transferring medical substances without the herein disclosed vessels and systems.

As used herein the term “ambient air particles” is interchangeable with the term “environmental air particles” and refers to air particles present in a non-filtered environment. For example, air can be purified by filters, such as a High Efficiency Particulate Air (HEPA) filter.

As used herein the term “connection interface” encompasses any surface, layer, plane or the alike that can be attached to a vessel. The term may encompass a structure that can be coupled to a vessel and that can engage with a complementary connection interface. In an embodiment of the invention, the connection interface may seal or cover an aperture of a vessel. In an embodiment of the invention, the connection interface may seal or cover an aperture for fluid passageway of a vessel. In an embodiment of the invention, the connection interface may plug an aperture or fluid passageway of a vessel. In an embodiment of the invention, the present invention discloses a first connection interface and a second connection interface. The first connection interface and the second connection interface may be similar or may be different in size and/or shape. In one or more embodiments, the exterior surface area facing ambient air, of the connection interfaces may be equal. In one or more embodiments, the exterior surface area facing ambient air, of the connection interfaces may be non-equal. In one or more embodiments, the difference in surface area between the exterior surface area of a plurality of connection interfaces is less than 0.3 inches squared. For example, less than 0.2 inches squared, or less than 0.1 inches squared. In an embodiment of the invention, the first and second connection interfaces when engaged with each other entrap ambient air particles therebetween. In an embodiment of the invention, the first and second connection interfaces when engaged with each other internally displace within a vessel. In one or more embodiments, the connection interface comprises or presents the form of a thin film layer. The connection interface may be manufactured from various materials, including, an elastic polymer. The connection interface may be made from a plastic material. The connection interface may be a rubber. The connection interface may be formed of a metal material (e.g., a metal alloy). The metal alloy may include, for example, aluminum. In one or more embodiments, the connection interface may be made of glass. In one or more embodiments, the connection interface is attached to, or is integrally formed with a medical vessel, or a port thereof. In one or more embodiments, the connection interface is detachable from the vessel. In one or more embodiments, the connection interface is displaceable from the vessel. In one or more embodiments, the first and second connection interfaces may be attached to or engage each other via various mechanisms. For example, the connection interfaces may be engaged via an engagement mechanism, such as a thread, a luer, an adhesive, a ratchet teeth mechanism, a retention member-keeper member mechanism and combinations thereof.

The connection interfaces may be coupled within any portion of the vessel. For example, the connection interfaces may be connected onto the vessels' body or aperture, or port thereof. In one or more embodiments, the connection interfaces may be surface mounted to a wall of a vessel. In one or more embodiments, the connection interfaces may be flush mounted to a wall of a vessel. In one or more embodiments, the connection interfaces may abut a wall of a vessel. In one or more embodiments, a plurality of internally displaceable connection interfaces may be attached and/or coupled to a vessel. In one or more embodiments, a plurality of connection interfaces may be flush mounted, surface mounted, and/or abut a wall of a vessel. In one or more embodiments the vessel is a container. In one or more embodiments, the container is a bag, bottle, or vial.

In one or more embodiments, the first connection interface and the second connection interface are configured to prevent contaminants from entering the fluid passageway between a first vessel and a second vessel.

In one or more embodiments, a first connection interface and a second connection interface are configured to prevent contaminants from contacting an internal compartment of the first vessel and/or the second vessel. In one or more embodiments, the internal compartment of the first and/or second vessel houses a beneficial substance. In one or more embodiments, the beneficial substance is a sterile fluid.

In one or more embodiments, a first connection interface and a second connection interface are configured to prevent contaminants from contacting an internal portion of a port of the first and/or second vessel.

As used herein the term “internal displacement” refers to a displacement (i.e., dislocation) of the herein disclosed first and/or second connection interfaces. In an embodiment of the invention, the displacement is internal, namely, dislocation into one of the vessels or vessel ports associated with a connection interface. In an embodiment of the invention, the displacement is within the fluid passageway established following engagement of the herein disclosed vessels. In an embodiment of the invention, the internal displacement occurs for one or both the first and second connection interfaces. The internal displacement may optionally occur simultaneously for both connection interfaces or may occur consecutively. The displacement may occur via a pressure exerted on the exterior of the connection interfaces, a twisting of the connection interfaces with respect to one another, or an engagement of the interfaces with one another and actuation by a user. Optionally, the displacement may occur via a pressure exerted through the exterior of a wall of a container, such as a bag, by a user's hand. Optionally, the displacement may occur via the manual manipulation of the first and/or second connection interfaces through the exterior wall of a container, such as a bag, by a force of the user's hand. In one or more embodiments, the term “internal displacement” refers to a displacement (i.e., dislocation) of herein disclosed third and/or fourth connection interfaces. In an embodiment of the invention, the displacement is internal, namely, dislocation into a decontamination connector and/or into a conduit of the decontamination connector.

In one or more embodiments, the connection interface is configured to hermetically seal an aperture present in or on a vessel. In accordance with this embodiment, following the internal displacement, a fluid passageway provides for the fluid communication between vessels.

As used herein the term “vessel” refers to any device utilized for containing and/or transferring substances as herein disclosed. In one or more embodiments, the vessels may be used for containing medical substances. In an embodiment of the invention, the vessel is a medical vessel. In an embodiment of the invention, the vessel is a medical device. In an embodiment of the invention, the vessels are used for, and adapted to allow connection to another vessel. In an embodiment of the invention, the vessel is utilized for containing a medical substance. Various types of vessels are contemplated. The vessel may be selected, without limitation, from a vial, a bag, a chamber, a bottle, and the alike. In an embodiment of the invention, the term vessel further encompasses elements that can be used to connect between vessels. In accordance with this embodiment, the vessel may be selected, without limitation, from a connector, a syringe, an infusion line, a tubing, a spike, a filter, a port and a manifold.

As used herein the term “fluid communication” refers to two or more vessels in which substances may pass therethrough either directly or indirectly. The fluid communication may occur via a fluid passageway that allows for the flow/transfer of substances. In one or more embodiments, the fluid passageway may allow the passage of fluids, liquids, powders, or solids. In one or more embodiments, the term “fluid communication” refers to a decontamination connector through which substance may pass therethrough between two or at least two vessels.

In an embodiment of the invention, the herein disclosed devices, systems and methods allow fluid communication in a contaminant-free, or substantially contaminant-free manner. For example, between three or more, four or more, five or more or six or more vessels. In an embodiment of the invention, the herein disclosed devices, systems and methods allow fluid communication between three, four, five, six, or seven vessels. For example, the devices, systems, and methods of the invention allow fluid communication between two bags, between a syringe and a bag, between a connector and a bag, between a connector and a vial, between a bag and a vial or between a syringe and a connector.

A further purpose of this invention is to provide a connection interface that reduces the presence of non-purified air and/or air particles. This invention focuses on connection interfaces that are substantially reduced of contaminants and ambient air particles and/or entirely contaminant free and entirely free of ambient air particles.

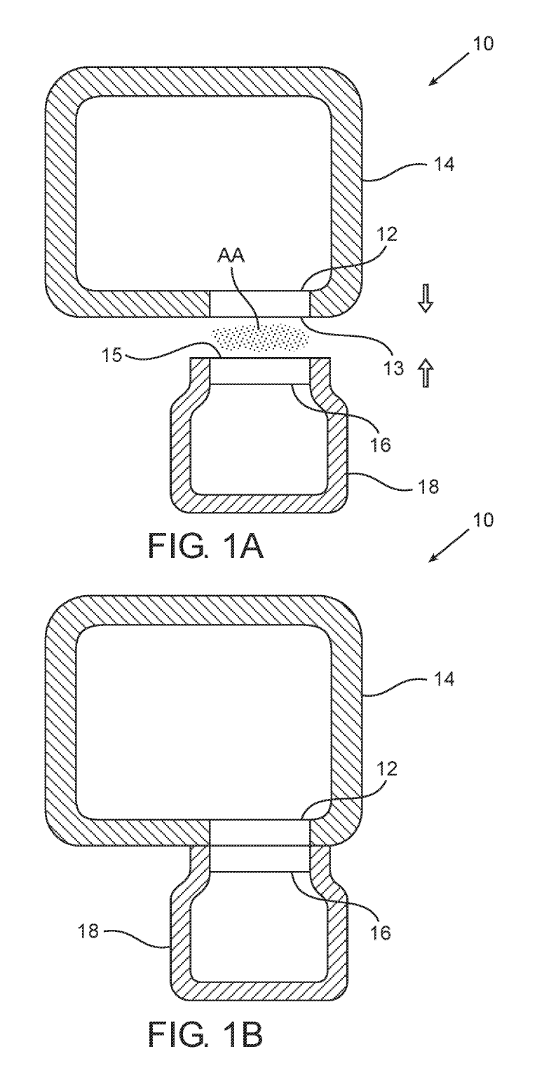

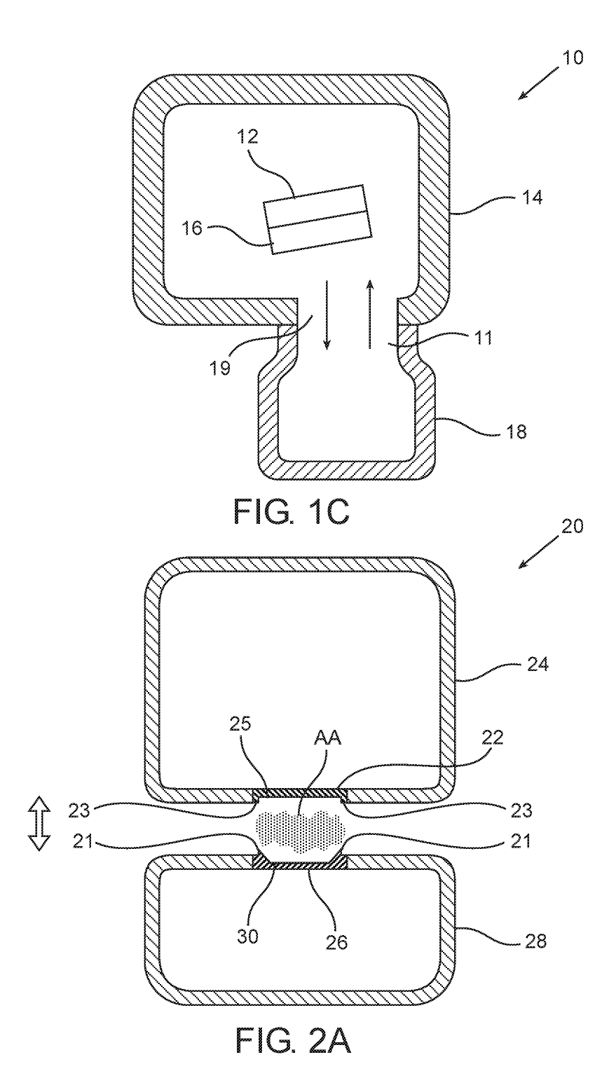

Referring now to the drawings, FIGS. 1A-1C illustrate schematically an exemplary system 10 for establishing a contaminant-free fluid passageway between vessels. System 10 includes a first connection interface 12 configured to be coupled to a first vessel 14 and a second connection interface 16 configured to be coupled to a second vessel 18.

The first and second vessels 14 and 18, respectively, may be any vessel capable for containing substances, such as medical substances. The vessels may be used as intermediate tools that connect between vessels. The vessels may be selected from a vial, a bag, a bottle, a syringe, an infusion line, a connector, a filter, a manifold, a bag port, a bottle port, a vial port, a spike and combinations thereof. The vessels may be similar in size and/or shape. Alternatively, the vessels may be different in size and/or shape.

In an embodiment of the invention, first connection interface 12 includes an exterior surface 13 which is exposed to AA particles and second connection interface 16 includes an exterior surface 15 which is exposed to AA particles. Exterior surfaces 13 and 15 may be substantially equal in surface area. In one or more embodiments, the first and/or second connection interfaces are attached to, optionally integrally manufactured with the corresponding first and/or second vessels.

FIG. 1A schematically illustrates system 10, wherein first connection interface 12 is coupled to first vessel 14 and second connection interfaces 16 is coupled to second vessel 18. First vessel 14 and second vessel 18 are spaced apart and ambient air AA particles surround the vessels and the connection interfaces. First and second connection interfaces 12 and 16, respectively are configured to engage with each other.

FIG. 1B schematically illustrates the engagement between first and second connection interfaces 12 and 16, respectively. The engagement between connection interfaces 12 and 16 entails an entrapment of ambient air AA particles. Accordingly, contaminants present within AA particles are entrapped between the interfaces 12 and 16.

It is important to be noted that the entire exterior surface of first connection interface 12 and second connection interface 16 are entrapped between the engagement between the first 12 and second 16 connection interfaces. The edges (sides/circumferential edges) of the first connection interface 12 and the second connection interface 16 are concealed within a wall or body of the first vessel 14 and second vessel 16. Optionally, the edges (sides/circumferential edges) of the first connection interface 12 and the second connection interface 16 are concealed within a port (not shown) of the first vessel 14 and second vessel 16. The edges (sides/circumferential edges) are not exposed to contaminants AA prior to and/or after engagement of the first connection interface 12 and second connection interface 16.

FIG. 1C illustrates system 10 wherein following engagement of the connection interfaces 12 and 16 an internal displacement of the connection interfaces 12, 16 within the first vessel 14 occurs while allowing for a contaminant-free fluid passageway and hermetically sealed connection of the vessels 14 and 18. An internal displacement of the first connection interface 12 and the second connection interface 16 establishes fluid communication between the first vessel 14 and the second vessel 18. It is to be noted that similar internal displacement of the connection interfaces 12 and 16 may alternatively occur within second vessel 18. In an embodiment of the invention, the first connection interface 12 and the second connection interface 16, internally displace concomitantly within vessel 14 following engagement therebetween the interfaces.

The first connection interface 12 prior to the internal displacement is configured to hermetically seal an aperture 19 in the first vessel 14. The second connection interface 16 prior to the internal displacement is configured to hermetically seal an aperture 11 in the second vessel 18.

In one or more embodiments, the engagement between the first vessel 14 and the second vessel 18 provides for an airtight engagement between the vessels.

In one or more embodiments, the vessels 14 and 18 and/or connection interfaces 12 and 16 are hermetically sealed upon engagement thereof and upon engagement of the connection interfaces 12 and 16.

In one or more embodiments, at least one of the first connection interface 12 and the second connection interface 16 is a selected from a group consisting of a film, a bung, a plug and combinations thereof. In one or more embodiments, the film is a plastic or a metal alloy. In one or more embodiments, the bung is made of a rubber or an elastomeric material.

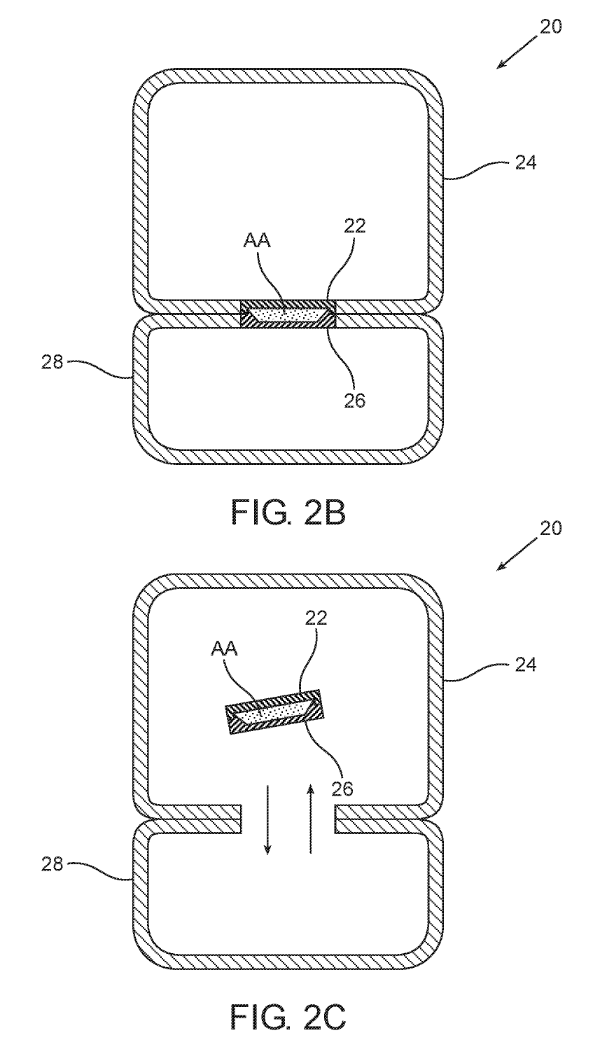

FIGS. 2A-2C illustrate schematically a further exemplary system for establishing a contaminant-free fluid passageway between vessels. System 20 includes a first connection interface 22 configured to be coupled to a first vessel 24 and a second connection interface 26 configured to be coupled to a second vessel 28. System 20 further includes protruding edges 21 positioned along a periphery of second connection interface 26. Edges 21 may end with a sharp tip. Edges 21 are further exposed to AA particles and are configured to allow an engagement with first connection interface 22 such that exposed edges 21 may be concealed within complementary edges 23 positioned along the circumference of connection interface 22. Accordingly, edges 21 and 23 snuggly fit to one another. Edges 21 are elevated relative to exterior surface 30 of connection interface 26 and edges 23 are elevated relative to exterior surface 25 of connection interface 22. Edges 23 are configured to isolate edges 21 being exposed to contaminants. Such arrangement of the edges 21 and 23 is configured to avoid the exposed edges 21 from contacting an internal compartment of the first vessel 24 and/or the second vessel 28 when the first connection interface 22 is engaged with the second connection interface 26. In one or more embodiments, the edges 23 of the first connection interface 22 and the edges of the second connection interface 26 contact each other thus isolating contaminants AA. In one or more embodiments, edges 23 and 21 are circumferential. In one or more embodiments, edges 23 of the circumference of the first connection interface 22 and edges 21 of the second connection interface 26 fully entrap the contaminants where no surface of the edges 21 and 23 that contact the internal compartment of the vessel is exposed to the contaminants.

FIG. 2A schematically illustrates system 20, wherein first connection interface 22 and second connection interface 26 and accordingly first vessel 24 and second vessel 28 are spaced apart.

FIG. 2B schematically illustrates the engagement between first and second connection interfaces 22 and 26, respectively. The engagement between first and second connection interfaces 22 and 26, respectively, entails an entrapment of contaminants present within AA particles.

FIG. 2C illustrates system 20 wherein following the engagement between the connection interfaces 22 and 26, the connections internally displace within the first vessel 24 while allowing for a contaminant-free fluid passageway and hermetically sealed engagement of the vessels. System 20 provides that when the first connection interface 22 and the second connection interface 26 internally displace within the first vessel 24, no portion of the connection interfaces 22 and 26 that are exposed to an internal cavity of the vessel 24 have been exposed to contaminants, allowing for a contaminant-free fluid passageway between the vessels 24 and 28. System 20 further provides that when first connection interface 22 and the second connection interface 26 internally displace within the first vessel 24, the entire surface of the first connection interface 22 and the second connection interface 26 that have been exposed to contaminants are isolated between the connection interfaces 22 and 26.

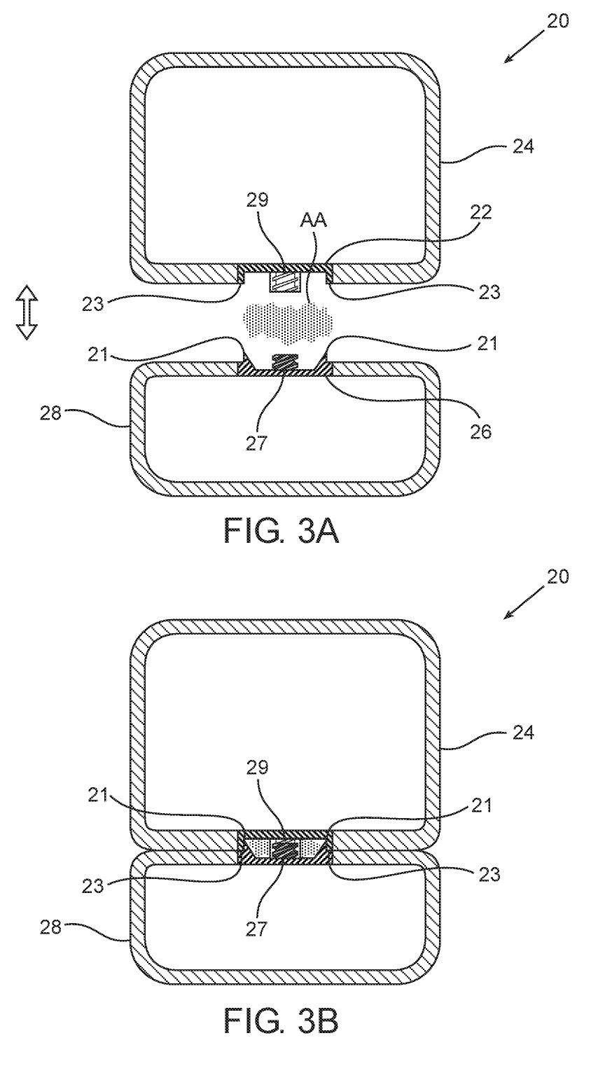

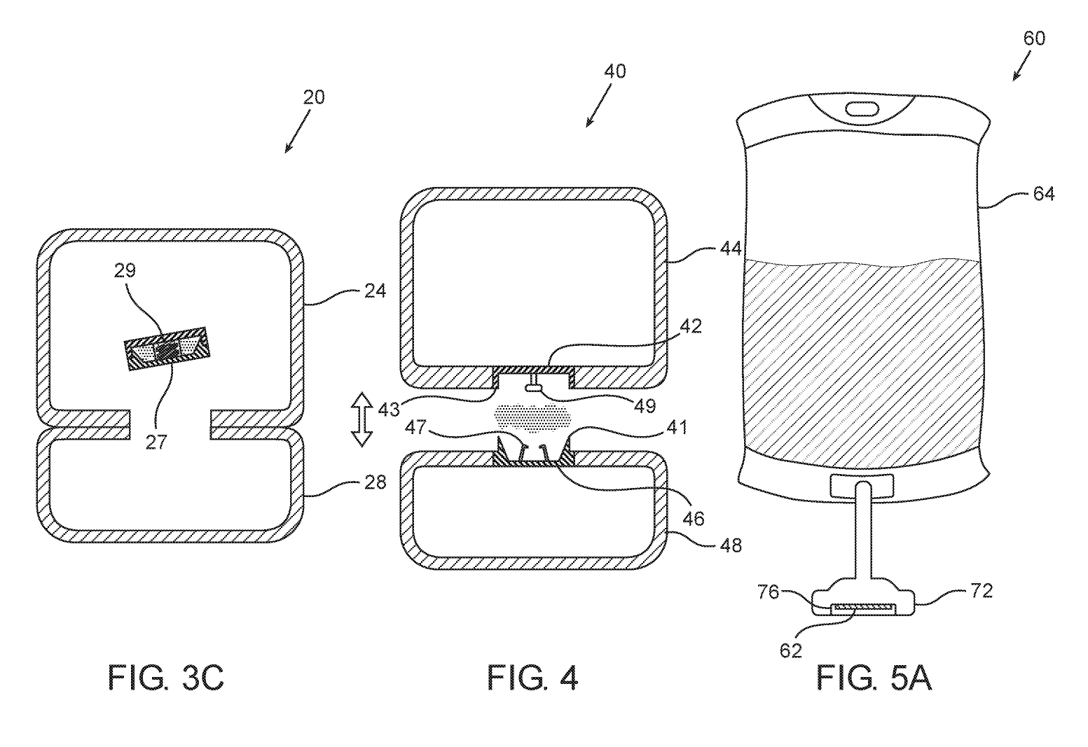

Referring now to FIGS. 3A-3C, system 20 is shown when further comprising an engagement mechanism that includes thread 29 positioned on first connection interface 22 and a complementary thread 27 positioned on second connection interface 26. The engagement mechanism is configured to securely engage the first and second vessels 24 and 28, respectively, and/or connection interfaces 22 and 26, respectively. In an embodiment of the invention, following the engagement between the connection interface 22 and connection interface 26, thread 29 and complementary thread 27 interlock with one another and an airtight seal between the first connection interface 22 and the second connection interface 26 is formed. Optionally, the thread may be position along the circumferential edges of connection interfaces 22 and 26, respectively.

FIG. 4 presents yet a further exemplary system 40 which is similar to system 20 with the exception that the engagement mechanism between first connection interface 42 and second connection interface 46 includes a retention member 49 and a keeper member 47 mechanism. Following an engagement between the interfaces 42 and 46, the keeper member 47 grabs retention member 49 and maintains retention member 49 as such as long as the interfaces 42 and 46 are maintained internally within vessel 44.

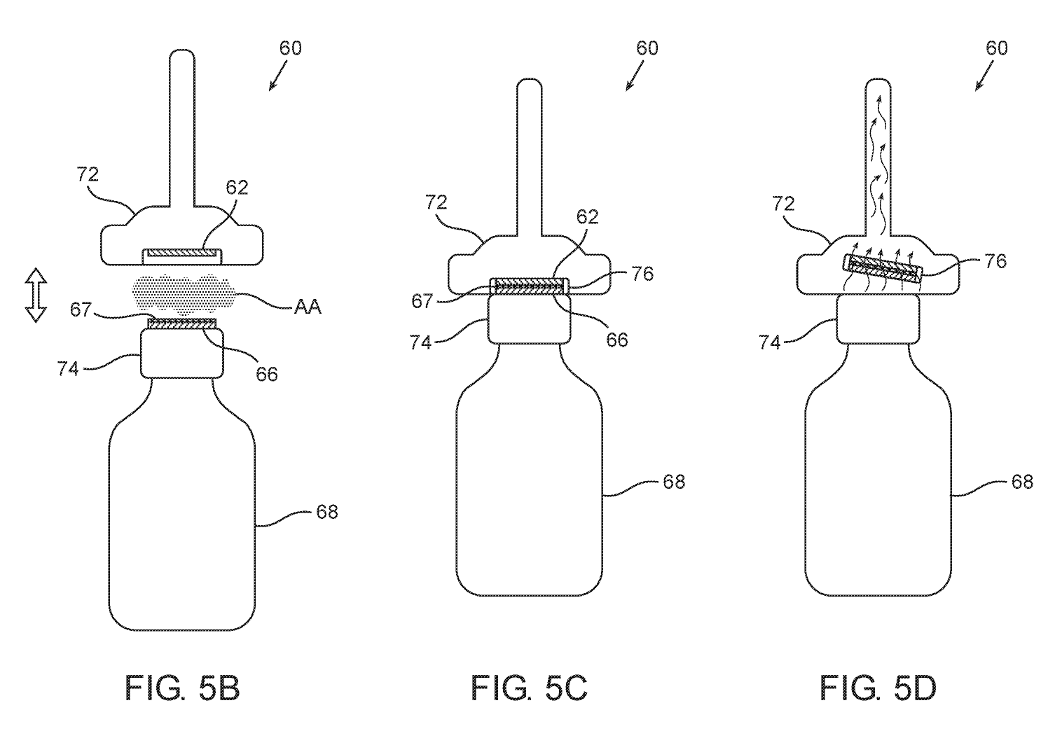

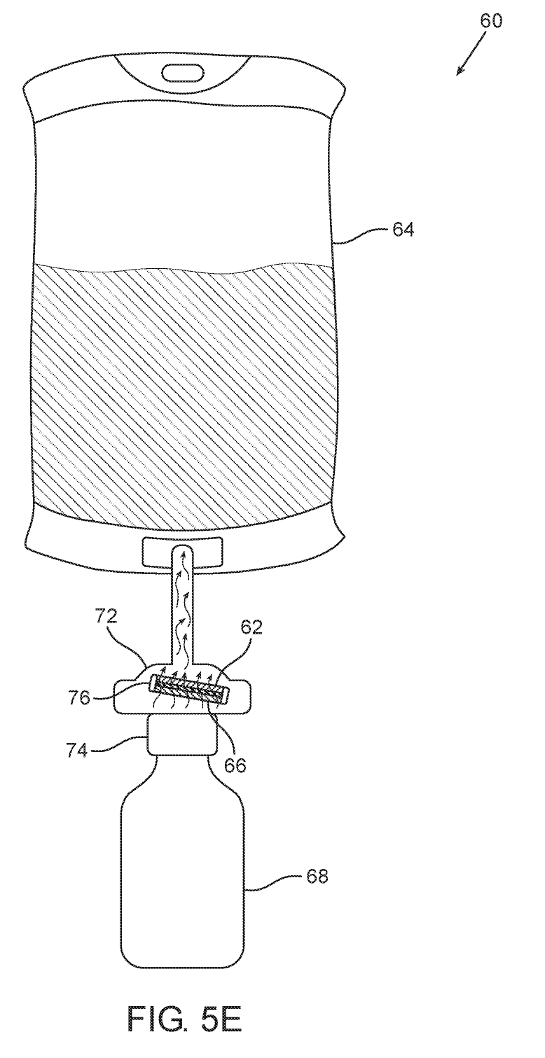

FIGS. 5A-5E illustrate yet a further exemplary system 60. System 60 includes a first connection interface 62 configured to be coupled to a first vessel 64, optionally via port 72. First connection interface 62 is configured to engage with second connection interface 66 present on a second vessel 68. Following an engagement between the connection interfaces 62 and 66, AA particles are entrapped between the first connection interface 62 and the second connection interface 66. First connection interface 62 is coupled to first vessel 64 via port 72 and second connection interface 66 is coupled to second vessel 68 via port 74. First connection interface 62 is disposed within seal case 76 present within port 72 and configured to accommodate first connection interface 62. In an embodiment of the invention, the entirety of first connection interface 62 is disposed within seal case 76. Seal case 76 is further configured to accommodate connection interface 66. In an embodiment of the invention, seal case 76 is configured to accommodate the portions of interface 66 which are exposed to AA particles.

FIG. 5A schematically illustrates system 60 that includes a first connection interface 62 coupled to a first vessel 64 via port 72.

FIG. 5B schematically illustrates system 60, wherein first connection interface 62 and second connection interface 66 are spaced apart and ambient air AA particles surround the vessels 64 and 68 and the connection interfaces 62 and 66.

FIG. 5C schematically illustrates the engagement between first and second connection interfaces 62 and 66, respectively. Second connection interface 66 may include an engagement mechanism in the form of an adhesive tape 67. In one or more embodiments, adhesive tape 67 may also be provided onto interface 62. The engagement between connection interfaces 62 and 66 affords an entrapment of AA particles therebetween the interfaces. Second connection interface 66 integrates within seal case 76 and engages first connection interface 62.

FIGS. 5D-5E illustrate an internal displacement of the interfaces 62 and 66 within port 72. The engagement followed by an internal displacement of the interfaces 62 and 66 allows a contaminant-free fluid passageway and hermetically sealed connection of the vessels 64 and 68. In an embodiment of the invention, seal case 76 is a hollowed member coupled within port 72. In an embodiment of the invention, seal case 76 is a hollowed member and internally displaces along with connection interfaces 62 and 66. Alternatively, seal case 76 is maintained in place while connection interfaces 62 and 66 internally displace within vessel 64. In an embodiment of the invention, seal case 76 is a hollow present within port 72. In an embodiment of the invention, seal case 76 is sized and shaped to accommodate first connection interface 62. In an embodiment of the invention, seal case 76 is sized and shaped to accommodate the entirety of first connection interface 62. In an embodiment of the invention, seal case 76 is sized and shaped to accommodate first connection interface 62 and at least a portion of second connection interface 66. In an embodiment of the invention, seal case 76 is sized and shaped to accommodate first connection interface 62 and at least the portions of second connection interface 66 that are exposed to AA particles. In an embodiment of the invention, seal case 76 is sized and shaped to accommodate first connection interface 62 and the entirety of second connection interface 66. Following the engagement of the first connection interface and the second interface, a hermetically coupled connection which is accompanied by a fluid passageway is formed between vessels 64 and 68. In one or more embodiments, seal case 76 abuts a wall of vessel 64. In one or more embodiments, seal case 76 is surface mounted or flush mounted to vessel 64. In one or more embodiments, interfaces 62 and 66 displace directly within vessel 64 or vessel 68.

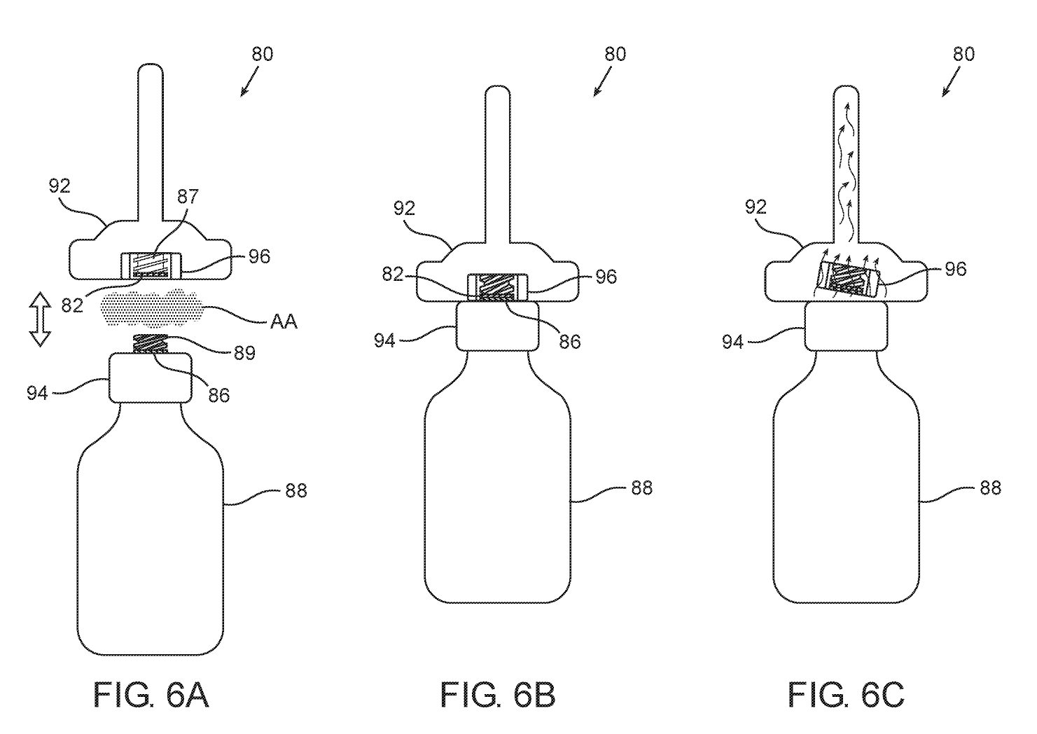

FIGS. 6A-6C illustrate yet a further exemplary system 80 that includes a first connection interface 82 coupled to first vessel 92. First connection interface 82 is configured to engage with second connection interface 86 present on second vessel 88, via port 94. Following an engagement between the connection interfaces 82 and 86, AA particles are entrapped between the first connection interface 82 and the second connection interface 86. First connection interface 82 is disposed within seal case 96 present within vessel 92 and configured to accommodate first connection interface 82. System 80 is similar to system 60 with the exception that it includes an engagement mechanism having a thread 89 and complementary thread 87 capable of interlocking one another.

FIG. 6A schematically illustrates system 80, wherein first connection interface 82 and second connection interface 86 are spaced apart and ambient air AA particles surround the vessels 92 and 88 and the connection interfaces 82 and 86.

FIG. 6B schematically illustrates the engagement between first and second connection interfaces 82 and 86, respectively, via thread 89 and complementary thread 87. The engagement between connection interfaces 82 and 86 affords an entrapment of ambient air AA particles therebetween the interfaces. Second connection interface 86 integrates within seal case 96 and engages first connection interface 82.

FIG. 6C illustrates an internal displacement of the interfaces 82 and 86 within vessel 92. The engagement followed by an internal displacement of the interfaces 82 and 86 allows a contaminant-free fluid passageway and hermetically sealed connection of the vessels 92 and 88. Seal case 96 is a hollow structured member that internally displaces along with connection interfaces 82 and 86.

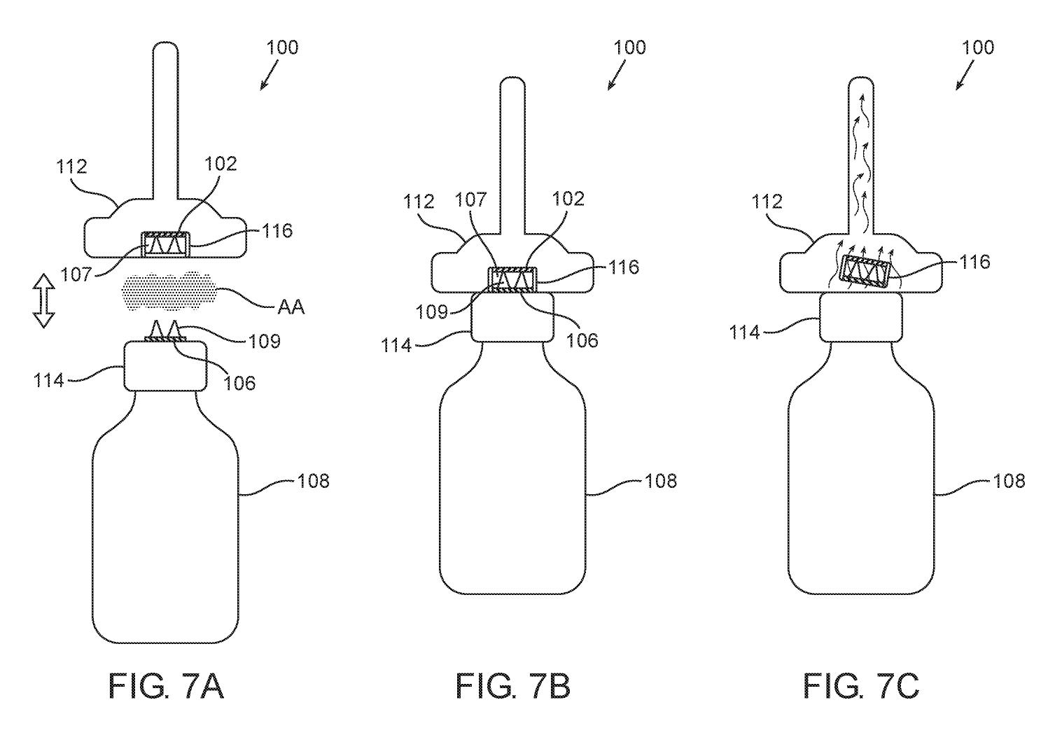

FIGS. 7A-7C illustrate yet a further exemplary system 100 that includes a first connection interface 102 coupled to first vessel 112. First connection interface 102 is configured to engage with second connection interface 106 present on second vessel 108. Following an engagement between the connection interfaces 102 and 106, AA particles are entrapped between the first connection interface 102 and the second connection interface 106. System 100 is similar to systems 60 and 80 with the exception that it includes an engagement mechanism having ratchet teeth 109 and 107.

FIG. 7A schematically illustrates system 100, wherein first connection interface 102 and second connection interface 106 are spaced apart and ambient air AA particles surround the vessels 112 and 108 and the connection interfaces 102 and 106.

FIG. 7B schematically illustrates the engagement between first and second connection interfaces 102 and 106, respectively, via ratchet teeth 107 and 109. The engagement between connection interfaces 102 and 106 affords an entrapment of ambient air AA particles therebetween the interfaces.

FIG. 7C illustrates an internal displacement of the interfaces 102 and 106 within vessel 112. The engagement followed by an internal displacement of the interfaces 102 and 106 allows a contaminant-free fluid passageway and hermetically sealed connection of the vessels 112 and 108. Seal case 116 is a hollow structured member that internally displaces along with connection interfaces 102 and 106.

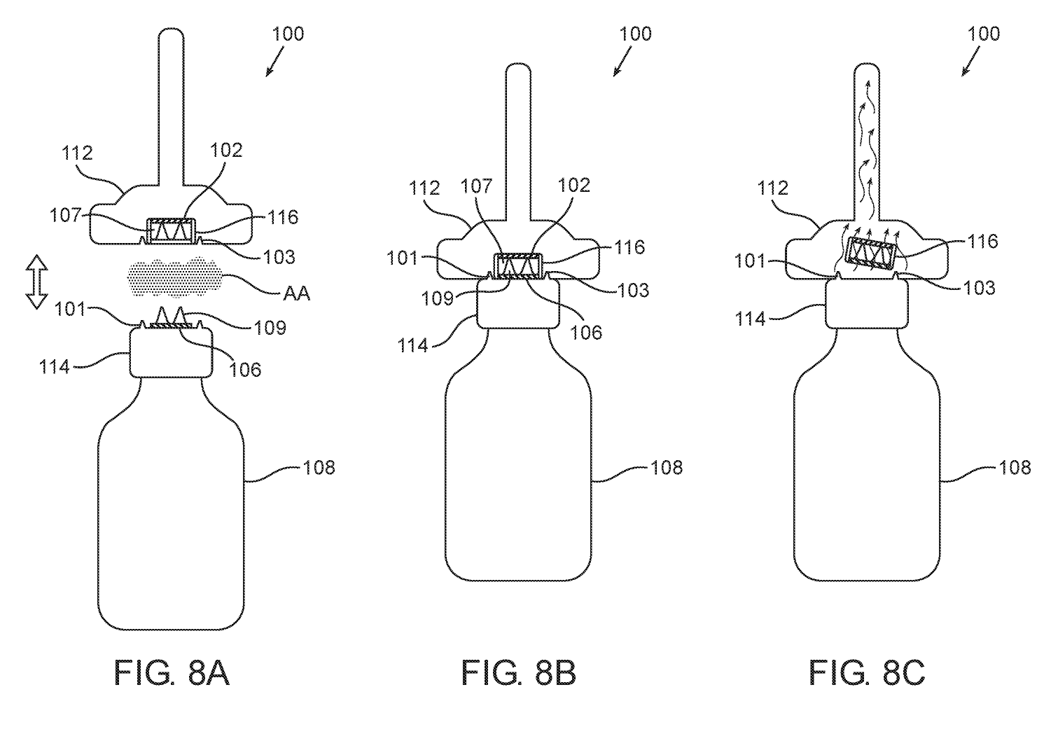

FIGS. 8A-8C illustrate system 100 that further includes an engagement mechanism between vessels 108 and 112 in the form of teeth 101 protruding outwardly from port 114 and engages a complementary retention member which may present the form of niche 103 positioned on vessel 112. The engagement mechanism 101-103 allows the secure engagement between the vessels 108 and 112. Various types of engagement mechanisms allowing secure engagement between the vessels are contemplated. For example, the engagement mechanism may be in the form of a thread, a luer, an adhesive tape, a ratchet teeth mechanism, and combinations thereof.

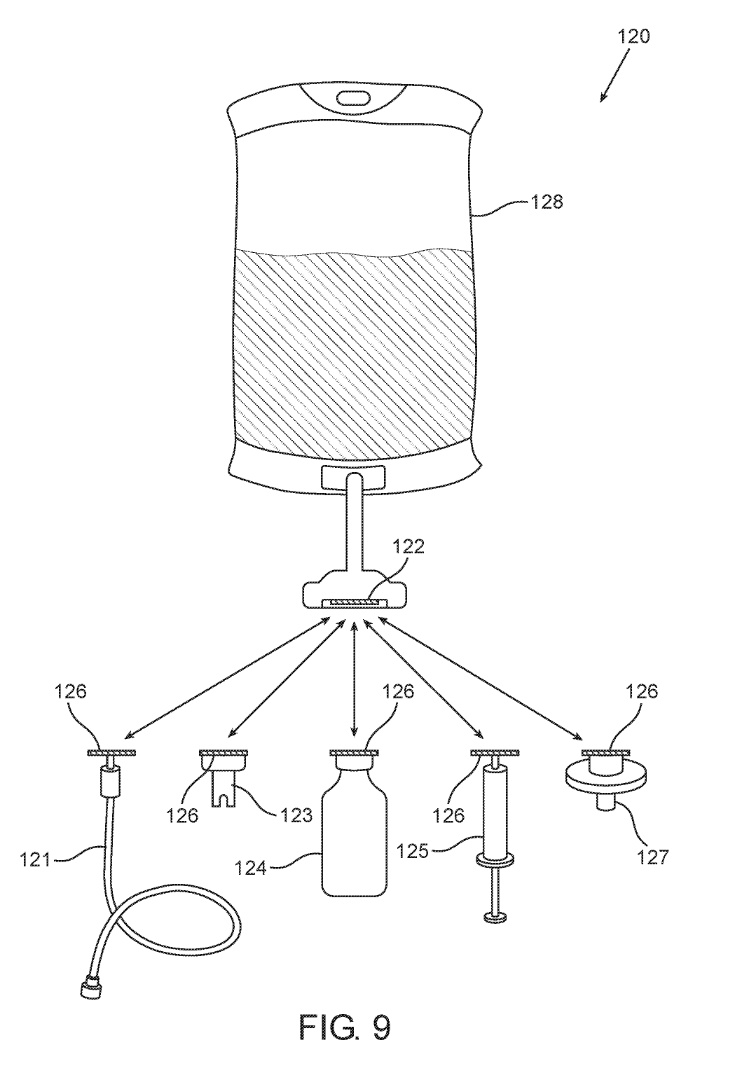

FIG. 9 presents system 120 which includes a first and a second connection interfaces, 122 and 126, wherein each of which may be coupled to various types of vessels. In an embodiment of the invention, first connection interface 122 may engage with second connection interface 126 which is coupled to infusion line 121. In an embodiment of the invention, first connection interface 122 may engage with second connection interface 126 which is coupled to connector 123. In an embodiment of the invention, first connection interface 122 may engage with second connection interface 126 which is coupled to vial 124. In an embodiment of the invention, first connection interface 122 may engage with second connection interface 126 which is coupled to syringe 125. In an embodiment of the invention, first connection interface 122 may engage with second connection interface 126 which is coupled to filter 127.

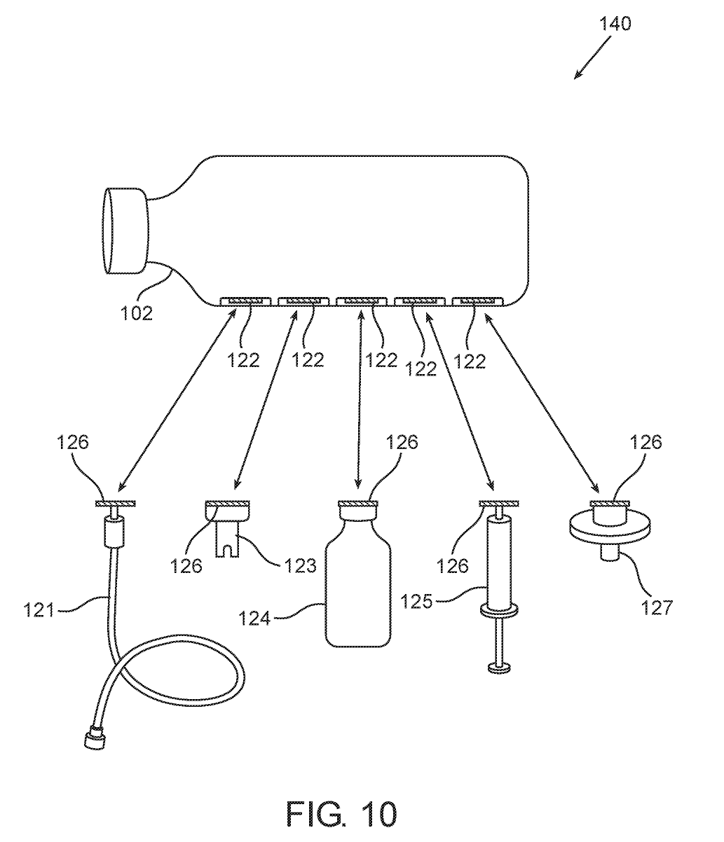

FIG. 10 schematically illustrates system 140 that includes a vessel which is vial 102 coupled to a plurality of connection interfaces 122 which can be coupled to connection interface 126 that is attached to infusion line 121, connector 123, vial 124, syringe 125, and/or filter 127. The plurality of connection interface 122 abut a wall of vial 102. Optionally, the plurality of connection interfaces 122 are flush mounted to vial 102. Optionally, the plurality of connection interfaces 122 may be surface mounted (not shown) to vial 102. Vial 102 may also be any container such as a bag, or a bottle. Vial 102 may be any vessel or device such as a manifold, or a connector with a plurality of openings/ports.

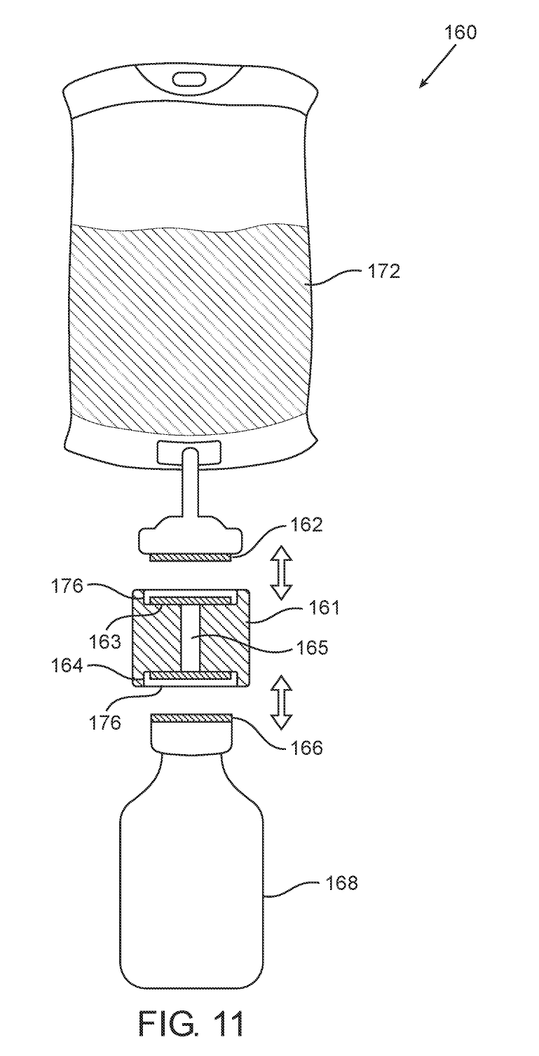

FIG. 11 illustrates system 160 that includes a first vessel 172 attached to first connection interface 162, and a second vessel 168 attached to a second connection interface 166. The system 160 further includes connector 161 that includes at opposing ends thereof a third connection interface 163 and a forth connection interface 164. The vessels 172 and 168 are configured to engage with each other via connection interface 162 that can be attached to third connection interface 163 and via second connection interface 166 that can be attached to forth connection interface 164. An internal displacement of the first and third connection interfaces 162 and 163, respectively, can occur within first vessel 172 and alternatively optionally within connector 161. Similarly, an internal displacement of the second and forth connection interfaces 166 and 164, respectively, can occur within second vessel 168 and alternatively optionally within connector 161. Connector 161 has a conduit 165 or internal chamber (not shown) of sufficient size to accommodate the internal displacement of connection interfaces 162,163 and/or the internal displacement of connection interfaces 166, 164. The engagement between the vessels via the connector 161 establishes a hermetic decontaminated engagement with a fluid passageway via conduit 165. Seal case 176 may be positioned within the one or more opposing edges of the connector 161 which is configured to accommodate both first connection interface 162 and third connection interface 163 and/or second connection interface 166 and forth connection interface 164. Conduit 165 of connector 161 provides for a fluid passageway between vessel 172 and vessel 168 after internal displacement of the connection interfaces. Connector 161 may further comprise a valve (not shown) disposed within or covering an opening/aperture of conduit 165, wherein the valve provides for the passage of a fluid between vessel 168 and vessel 172. The valve may be a one-way valve to prevent backflow of fluid from vessel 172 to vessel 168 or vice versa.

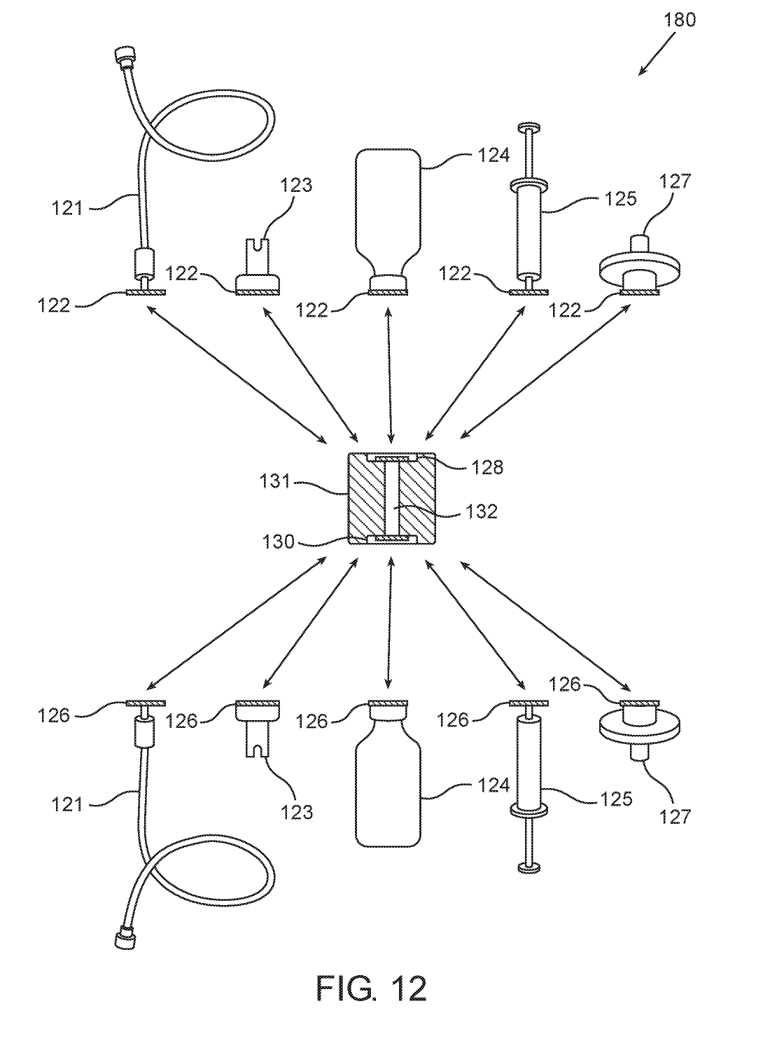

FIG. 12 depicts system 180 which is similar to system 160 in that it includes a first connection interface 122 and a second connection interface 126 each of which may be coupled to a medical vessel or device of various types such as infusion line 121, connector 123, vial 124, syringe 125, or filter 127. The system 180 further includes a connector 131 attached at opposing ends thereof to a third connection interface 128 and a forth connection interface 130. First connection interface 122 may engage with third connection interface 128 and second connection interface 126 may engage with forth connection interface 130. The engagement of the interfaces allows to entrap air particles therebetween the interfaces. The interfaces can internally displace within the vessel or within the connector allowing a hermetic decontaminated engagement with fluid passageway between the engaged vessels. Conduit 132 of connector 131 provides for a fluid communication between the vessels.

The present invention further provides a method of decontaminating a connection between two vessels, the method comprising the steps of: providing a first connection interface attached to a first vessel; providing a second connection interface attached to a second vessel, engaging the first vessel to the second vessel; and internally displacing the first and second connection interfaces within one of the first vessel or the second vessel, while a hermetically sealed connection between the first and second vessel is maintained.

In one or more embodiments, the first connection interface has edges configured to isolate an entire surface of the first connection interface that is exposed to contaminants from contacting an internal compartment of the first vessel and/or the second vessel when the first connection interface is engaged with the second connection interface, and wherein the second connection interface is configured to engage with the first connection interface, the second connection interface having edges configured to isolate an entire surface of the second connection interface that is exposed to contaminants from contacting an internal compartment of the first vessel and/or second vessel when the second connection interface is engaged with the first connection interface.

In one or more embodiments, the first connection interface has edges configured to isolate at least a portion of the surface of the first connection interface that is exposed to contaminants from contacting an internal compartment of the first vessel and/or a second vessel when the first connection interface is engaged with the second connection interface, and wherein the second connection interface has edges configured to isolate at least a portion of the surface of the second connection interface that is exposed to contaminants from contacting an internal compartment of the first vessel and/or second vessel when the second connection interface is engaged with the first connection interface.

In one or more embodiments, an airtight seal is formed between the first connection interface and the second connection interface prior to the internal displacement of the first and second connection interfaces. In one or more embodiments, when the airtight seal between the first connection interface and the second connection interface is displaced, the connection between the first vessel and the second vessel is decontaminated.

In one or more embodiments, circumferential edges of at least one of or both of the first and second connection interfaces ends are concealed within the airtight seal, allowing for sterile internal displacement.

In one or more embodiments, the external portion of the circumferential edges of at least one of or both of the first and second connection interfaces are concealed within the airtight seal between the first and second connection interface, allowing for sterile internal displacement and contaminant-free engagement of vessels.

In one or more embodiments, when the circumferential edges of both the first and second connection interfaces ends are aligned, an airtight seal is formed between first and second connection interfaces, allowing for internal displacement of first and second connection interfaces and a contaminant free fluid passageway between the first and second vessels. In one or more embodiments, the method further comprises connecting the first connection interface to the second connection interface via an engagement mechanism.

In one or more embodiments, connecting of the first connection interface to the second connection interface is selected from a twisting of a thread onto a complementary thread, attaching ratchet teeth to a complementary retention member, and adhering a first connection interface to the second connection interface via an adhesive.

In one or more embodiments, the engagement of first connection interface to the second connection interface occurs prior to internal displacement of the connection interfaces. In one or more embodiments, the engagement of first connection interface to the second connection interface occurs concomitantly or at about the time of internal displacement of the connection interfaces.

Each of the following terms: ‘includes’, ‘including’, ‘has’, ‘having’, ‘comprises’, and ‘comprising’, and, their linguistic, as used herein, means ‘including, but not limited to’, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof. Each of these terms is considered equivalent in meaning to the phrase ‘consisting essentially of’.

Each of the phrases ‘consisting of’ and ‘consists of’, as used herein, means ‘including and limited to’.

The term ‘method’, as used herein, refers to steps, procedures, manners, means, or/and techniques, for accomplishing a given task including, but not limited to, those steps, procedures, manners, means, or/and techniques, either known to, or readily developed from known steps, procedures, manners, means, or/and techniques, by practitioners in the relevant field(s) of the disclosed invention.

Throughout this disclosure, a numerical value of a parameter, feature, characteristic, object, or dimension, may be stated or described in terms of a numerical range format. Such a numerical range format, as used herein, illustrates implementation of some exemplary embodiments of the invention, and does not inflexibly limit the scope of the exemplary embodiments of the invention. Accordingly, a stated or described numerical range also refers to, and encompasses, all possible sub-ranges and individual numerical values (where a numerical value may be expressed as a whole, integral, or fractional number) within that stated or described numerical range. For example, a stated or described numerical range ‘from 1 to 6’ also refers to, and encompasses, all possible sub-ranges, such as ‘from 1 to 3’, ‘from 1 to 4’, ‘from 1 to 5’, ‘from 2 to 4’, ‘from 2 to 6’, ‘from 3 to 6’, etc., and individual numerical values, such as ‘1’, ‘1.3’, ‘2’, ‘2.8’, ‘3’, ‘3.5’, ‘4’, ‘4.6’, ‘5’, ‘5.2’, and ‘6’, within the stated or described numerical range of ‘from 1 to 6’. This applies regardless of the numerical breadth, extent, or size, of the stated or described numerical range.

Moreover, for stating or describing a numerical range, the phrase ‘in a range of between about a first numerical value and about a second numerical value’, is considered equivalent to, and meaning the same as, the phrase ‘in a range of from about a first numerical value to about a second numerical value’, and, thus, the two equivalently meaning phrases may be used interchangeably.

The term ‘about’, is some embodiments, refers to ±30% of the stated numerical value. In further embodiments, the term refers to ±20% of the stated numerical value. In yet further embodiments, the term refers to ±10% of the stated numerical value.

It is to be fully understood that certain aspects, characteristics, and features, of the invention, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the invention which are illustratively described and presented in combination or sub combination in the context or format of a single embodiment, may also be illustratively described and presented in the context or format of a plurality of separate embodiments.

Although the invention has been described in conjunction with specific embodiments thereof, it is evident that many alternatives, modifications, and variations will be apparent to those skilled in the art. Accordingly, it is intended to embrace all such alternatives, modifications, and variations that fall within the spirit and broad scope of the appended claims.

All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of decontaminating a connection between two vessels, the method comprising the steps of:
providing a first connection interface attached to a first vessel;
providing a second connection interface attached to a second vessel,
engaging said first vessel to said second vessel; and
internally displacing said first and second connection interfaces within one of said first vessel or said second vessel, while a hermetically sealed connection between said first and second vessel is maintained.

2. The method of claim 1, wherein the first connection interface has edges configured to isolate an entire surface of the first connection interface that is exposed to contaminants from contacting an internal compartment of said first vessel and/or said second vessel when the first connection interface is engaged with the second connection interface, and wherein the second connection interface is configured to engage with the first connection interface, the second connection interface having edges configured to isolate an entire surface of the second connection interface that is exposed to contaminants from contacting an internal compartment of said first vessel and/or second vessel when the second connection interface is engaged with the first connection interface.

3. The method of claim 1, wherein the first connection interface has edges configured to isolate a portion of the surface of the first connection interface that is exposed to contaminants from contacting an internal compartment of said first vessel and/or a second vessel when the first connection interface is engaged with the second connection interface, and wherein the second connection interface has edges configured to isolate a portion of the surface of the second connection interface that is exposed to contaminants from contacting an internal compartment of said first vessel and/or second vessel when the second connection interface is engaged with the first connection interface.

4. The method of claim 1, wherein an airtight seal is formed between the first connection interface and the second connection interface prior to said internal displacement of said first and second connection interfaces.

5. The method of claim 4, wherein when the airtight seal between the first connection interface and the second connection interface is displaced, the connection between said first vessel and said second vessel is decontaminated.

6. The method of claim 1, wherein circumferential edges of at least one of or both of said first and second connection interfaces ends are concealed within said airtight seal, allowing for sterile internal displacement.

7. The method of claim 1, wherein when the circumferential edges of both said first and second connection interfaces ends are aligned, an airtight seal is formed between first and second connection interfaces, allowing for internal displacement of first and second connection interfaces and a contaminant free fluid passageway between the first and second vessels.

8. The method of claim 1, further comprising connecting the first connection interface to the second connection interface via an engagement mechanism.

9. The method of claim 1, wherein the connecting of the first connection interface to the second connection interface is selected from a twisting of a thread onto a complementary thread, attaching ratchet teeth to a complementary retention member, and adhering a first connection interface to the second connection interface via an adhesive.

10. The method of claim 1, wherein the engagement of first connection interface to the second connection interface occurs prior to internal displacement of said connection interfaces.

11. A decontamination connector for decontaminating a connection between a first vessel and a second vessel, the decontamination connector comprising:
a first connection interface configured to be coupled to a first vessel, the first connection interface configured to engage with a second connection interface on a second vessel to entrap contaminants between the first connection interface and the second connection interface,
wherein following said engagement of the first connection interface and said second interface, said decontamination connector and said first vessel form a hermetically coupled connection with said second vessel, while the first connection interface and said second interface are internally displaced within said first vessel or said second vessel while maintaining the hermetically coupled connection.

12. The decontamination connector of claim 11, wherein the first connection interface and the second connection interface are configured to prevent contaminants from contacting the fluid passageway established between the decontamination connector and the first vessel.

13. The decontamination connector of claim 11, wherein the first connection interface is configured to hermetically seal an aperture of the decontamination connector.

14. The decontamination connector of claim 13, wherein the first connection interface is configured to be internally coupled within said aperture of said decontamination connector.

15. The decontamination connector of claim 14, wherein said aperture is a port.

16. The decontamination connector of claim 11, further comprising an engagement mechanism configured to securely engage said decontamination connector with said first vessel.

17. The decontamination connector of claim 11, wherein said engagement mechanism provides an airtight engagement between said decontamination connector and said vessel.

18. The decontamination connector of claim 16, wherein said engagement mechanism is selected from a thread, a luer, ratchet teeth mechanism, adhesive, and combinations thereof.

19. The decontamination connector of claim 16, wherein said engagement mechanism is located on the first connection interface.

20. The decontamination connector of claim 16, wherein engagement mechanism engages a complimentary engagement mechanism on a second connection interface

21. The decontamination connector of claim 20, wherein the engagement mechanism forms an airtight seal between the first connection interface and the second connection interface.

22. The decontamination connector of claim 11, wherein the first connection interface is integrally connected to said decontamination connector.

23. The decontamination connector of claim 11, wherein said decontamination connector and said vessel are hermetically sealed upon engagement of the first and second connection interfaces.

24. The decontamination connector of claim 11, wherein the internal fluid passageway between said decontamination connector and vessel is devoid of air particles.

25. The decontamination connector of claim 11, wherein the internal fluid passageway between said decontamination connector and vessel is sterile.
